(19) United States
(12) Patent Application Publication
(10) Pub. No.: US 2010/0061503 A1
(43) Pub. Date: Mar. 11, 2010

(54) Pseudo-capacitor structure for direct nuclear energy conversion

(76) Inventor: Liviu Popa-Simil, Los Alamos, NM (US)

Correspondence Address: Liviu POPA-SIMIL, 3213-C Walnut St., Los Alamos, NM, 87544-2092, US

(21) Appl. No.: 12/384,074

(22) Filed: Mar. 31, 2009

Related U.S. Application Data
(63) Continuation of application No. 11/603,812, filed on Nov. 21, 2006.

(51) Int. Cl. G21C 3/00

(52) U.S. Cl. 376/409

(57) ABSTRACT

Direct nuclear energy conversion into electricity device based on nano-hetero-structures with applications in nuclear reactors and radioisotope batteries. The nano structure may be made by a repeated customized sequence of nano-layers generically called “CIci” The structure may also be made by a series of structures evolved from CIci as nanoplasmon, nanowire, nano-tube. The Structure relies on knock on electron avalanche produced by stopping radiation that is generated by the high electron density conductor material “C” that tunnels through insulator “I” and accumulates in the low density conductor “c”. The “C” material is producing no electrons to cross the associate insulator “i” therefore remains negatively charged by the electron shower, and discharges through a resistor connected to th “C” later. The nanoplasmon structure exhibits thermal direct conversion properties by radiation switched mechanism that is generated by the plasmon-phonon resonance. The device has ultra-capacitive properties when made with carbon nanotubes. The device is useful for a direct conversion nano-battery or for nuclear reactor direct conversion structure. It may also be used as a radiation energy harvesting device when made with actinides for neutro-capture and amplification.

### CROSS REFERENCE TO RELATED APPLICATIONS

This application claims the benefit of U.S. Provisional Application Ser. No. 11/603,812 filled on Nov. 21, 2006, which is hereby incorporated by reference in this entity.

### BACKGROUND

The present invention is a detail development of the Invention Application 60/748489 filled in Nov. 21, 2006, entitled Method for Developing Nuclear Fuel and Its Applications.

In fact when apply the method of the three materials (source, separator, absorber and module separator) to find the effective length for the knock-on electrons the second important agent in nuclear process energy release, the structure and the dimensions are occurring as the main result.

Starting from 1913 with Moesley cell many attempts have been made to obtain the direct nuclear energy conversion into electricity that failed to deliver because of incomplete understanding of the process and materials at the subatomic level.

The interactions involved in the process that are better understood in this development are related to the interaction of the moving nuclear particles with atomic fields, driving to nuclear energy degradation by sharing it to avalanches of knock-on particles, mainly electrons, stopped in nano-size materials. The process of evaluation, design and buildup drives to several versions of capacitor like structures.

The evolution of the idea from the first cells based on direct charge accumulation to the present converters in nano structures showed that to obtain acceptable conversion efficiency is necessary to understand and deal with the whole complexity of nuclear and atomic processes occurring at the interaction between radiation and structured matter.

### SUMMARY

The present invention refers to a method of converting directly into electricity the energy of various radiations, with emphasis on charged particles produced by fusion, fission and nuclear decay.

The nano-structures used have to consider both the initial nuclear radiation and the resulted electron avalanches properties in order to attain an optimal structure with maximal efficiency.

There are several possible structures that may produce the direct conversion of radiation the main being the planar structure, the nano-clustered structure and the nano-structures as (complex multi wall nano-wires and nano-tubes), each having specific features.

The structures developed based on these consideration show increased potential conversion efficiency, but the final constructive solution determines the overall parameters.

The nano-cluster resonance structures exhibits supplementary properties as super-thermal conductivity based on plasmon- electron-polaron resonance in switched electric thermal conductivity, representing a supplementary feature of the devices.

The direct conversion layers may be packed in various configurations, the smallest efficient power element reaching dimensions of a cube with laterals two radiation range long (about 10-50 microns long) and powers depending on the primary nuclear radiation source properties.

The applications of these power sources as nuclear fuel, when contains actinides isotopic battery, when the radioisotope is placed at the borders of the harvesting cell or fusion and beam radiation harvesting when there is fabricated as a tile with no radioactive material included in the structure or near-by.

The maximal theoretic power density is up to 4 orders of magnitude higher than the actual power densities obtained in nuclear reactors of up to 1 kW/cm³ reaching more than 5 MW/cm³ respectively. The real maximal power a such structure can handle is given by the conversion efficiency, because the unconverted power turns into heat that have to be removed in order to maintain the operation temperature.

Even at lower efficiencies, comparable with the present ones obtained in thermo-electric nuclear power structure, the application of the direct conversion remains important due to drastic reduction in equipments.

### BRIEF DESCRIPTION OF THE DRAWINGS

FIG. 1—Radiation particle energy deposition in matter 100 MeV ¹⁴⁰Cs in UO₂

FIG. 2—Radiation interaction with C atoms as a subatomic process exemplification

FIG. 3—Radiation power deposition by ionization in a sandwich of thin layered material 5 MeV ⁴He, as an exemplification of the radiation power deposition process as the base of this invention.

FIG. 4—Main embodiment of the invention meant to assure the correct operation of alternate layers stopping norm by specific range, dotted lines showing the effect of alternate hereto-structures in the simplest shape of layers

FIG. 5—A detail of the main embodiment of the invention showing the atomistic view of the particle interaction with alternate layer hetero-material, forming the (Conductor-Insulator-conductor)-insulator also called “CIci” structure, the elementary brick of the structure

FIG. 6—Knock-on electron distribution simulated by e-Casino, showing the electron avalanche formation in C layer and its absorption in c layer as an embodiment of the invention

FIG. 7—e-Casino electrons path in a Cici structure formed by Au, SiO₂/Al₂O₃, Al, Alumina as a mock structure and embodiment of the invention

FIG. 8—Electronic optimization of the nano-layers as a embodiment of the invention and a particularization of the method described in previous patent at the electron gas level as tool of designing the structure

FIG. 9—Multi-layered concept for fission products application, as a detaliation of the fission-products application

FIG. 10—Example of thickness calculation of a CIci elementary cell based on mezoscopic evaluations as an embodiment of the invention

FIG. 11—Example of radioactive battery structure as embodiment of the invention being similar to that for fusion and fission products energy harvesting

FIG. 12—Example of planar alpha radioisotopes battery structure as a particularization of the harvesting structure

FIG. 13—A main embodiment of the invention showing the structural morphing from parallel capacitor FIG. 13A, to nano-particulate capacitor and super dielectric creation based on plasmon nano-cluster resonance FIG. 13D.

FIG. 14—Another embodiment of the invention referring to parallel plasmon nano-cluster cell for radiation harvesting and radiation switched thermo-electrics

FIG. 15—Another embodiment of the invention showing the Nano-cluster plasmonic structure as special properties super-capacitor.

FIG. 16—Another embodiment of the invention made by the development of MWNano Structure—coated nanowire or carbon nanotube ultra capacitor structure

FIG. 17—Table with properties of the structures and evaluation of the various versions of development of the direct power conversion structures

FIG. 18—Synthetic view of Power density versus duration and collateral radiation of several isotopes, referring to the isotopic batteries as a byproduct of the invention

FIG. 19—Synthetic placement of the new power sources on the fuels, storage devices map, showing the superiority of the new developments over the present structures

FIG. 20—A main embodiment of the invention, as a consequence of the application of the method to fission products release in order to generate the fusion between micro and nano structure to create fission products clean micro-nano-structures

FIG. 21—Ionization power deposition of fission products into a sandwich micro-nano-structure as a exemplification of the structure application to fission products energy harvesting

FIG. 22—²¹⁰Po decay scheme as application on isotopic short life high power isotopic batteries

FIG. 23—²¹⁰Po energetic levels structure as an exemplification of the complexity of the nuclear reaction channels used in the battery

FIG. 24—The integrated direct harvesting structure into a cer-liq microstructure as another main embodiments of the structure.

FIG. 25—Nuclear reactor energy conversion cycle simplification from the present nuclear-thermal-mechanical-electric cycle, resulted by applying the direct nuclear fission conversion into electric power instead.

FIG. 26—Electric power conversion DC/AC MEMS inverter.

### DETAILED DESCRIPTION

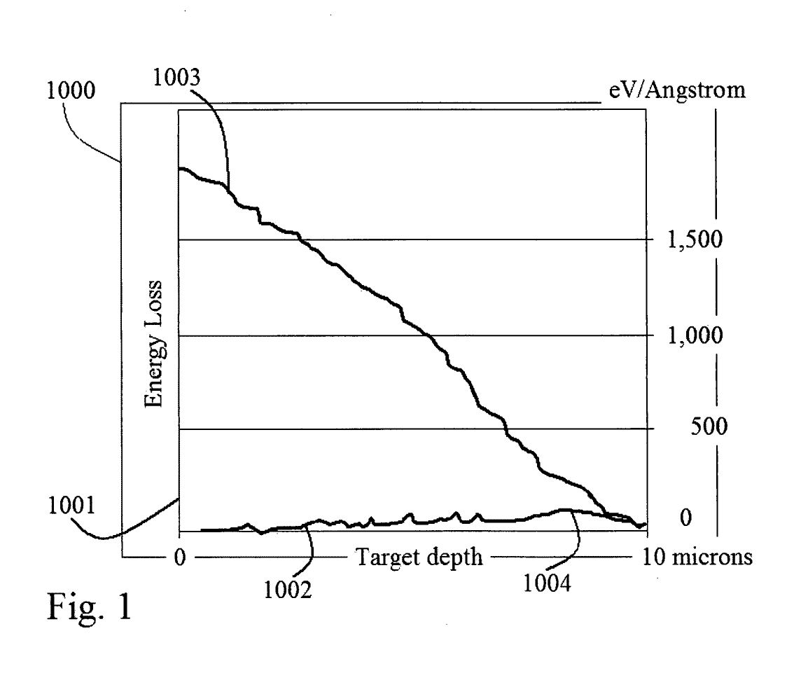

FIG. 1—shows radiation, nuclear particle energy deposition in matter with exemplification for 100 MeV ¹⁴⁰Cs in UO₂ as being a typical case of fission product, as base of further developments.

It shows the Energy loss versus depth values 1000 of the incident radiation interacting with matter that slows down mainly by the interaction between the moving particle and electron structures surrounding the atoms.

Chart's ordinate giving particle Energy Loss in (eV/Angstrom) for 5 MeV alpha in U 1001, chart's abscise giving the Target Depth in (micrometers) 1002.

During the interaction the radiation dislocates the electrons by direct electro-dynamic field collision generating high-energy knock-on electrons, showed as the Ionization curve on the chart 1003.

These electrons also called delta-electrons collides with other electrons sharing the energy until it becomes small at the phonon energy level and in this moment the electrons are returning in the initial position under the electric field of polarization the structures making a loop trajectory, and transferring all their energy into phonons.

A part of the collision energy is transferred to X-ray emission by atomic level excitation that travels micron distances until resonantly is absorbed generating electron showers. If the delta electrons were conserving the initial impulse the electromagnetic X-ray energy in almost omni-directional contributing to energy spread.

Towards the end of the range the nuclear collision interactions between the stopping radiation particle and lattice nuclei is intensifying and this is the domain of so called radiation damage based on nuclear dislocations, represented on chart as the energy loss in recoil creation 1004.

FIG. 1 shows that a ¹⁴⁰Cs atom being implanted in an uranium carbide lattice with about 100 MeV similar to the case of fission products is traveling less than 10 microns stopping range being of about 8.2 microns with a straggling of +/−1 micron.

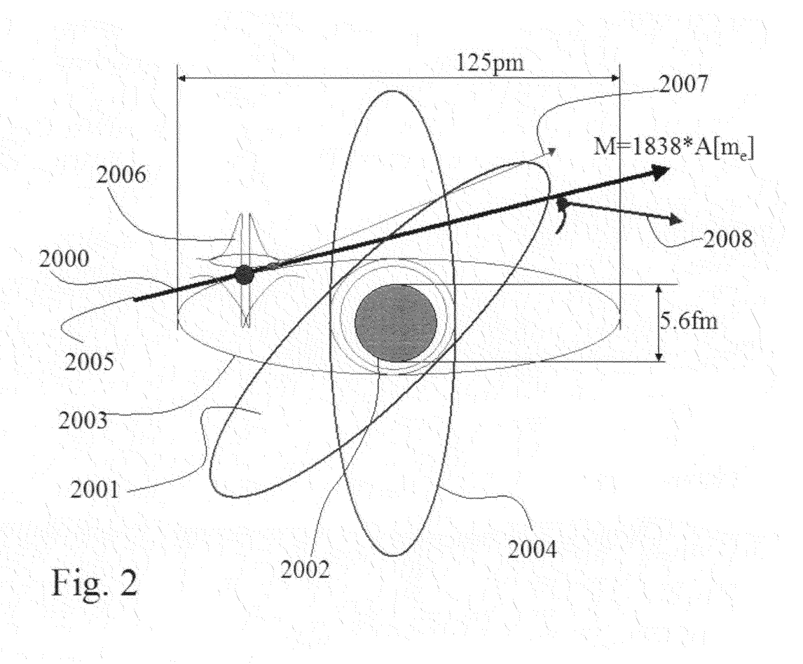

FIG. 2—shows an example of the interaction of the nuclear particles with atoms 2000 particularized on radiation interaction with C atoms, gives a detail of the interaction between a charged particle in blue and the electrons in C structures.

The atom structure (a Carbon atom) 2001 is made of the atom's nucleus 2002 having the estimated size of 5.6 fm, being further made of 6 protons and 6 neutrons totaling 36 up and 36 down quarks, combined in a more stable structure.

Electron orbital with distributed charge mass, 2003 reflects the C atomic charge number “Z” having 1s²; 2s² and let's say 2pₓ¹. 2p_{y}¹ orbital occupied with electron in particle stand 2004 shape, while there is possible as the quantum mechanic shows to be transferred and make a stand on any allowed, according to fermion selection rules, orbital to take a mass-charge stand and interact.

The moving nuclear particle 2005 interacts by the electric potential interaction 2006 with the electron knocking-on the electron 2007.

The electron is trapped by the mowing field of the radiation also showing interaction shaped orbitals and removed from the initial orbital while not completely trapped and stabilized on moving particle orbital system becoming a knock-on electron by central moving potential electric field acceleration 2008.

It has to be understood from here that the ionization nuclear collision is made mainly by the electric force field component and the maximal speed the electron may get is less than two times initial nuclear particle speed. That helps the understanding of the fact that there is possible that two or more electrons to be extracted from an atom.

The advantage of C atom, presented in FIG. 2 is related to its nuclear increased stability and the stability of sp² sp³ orbitals that gives the strong chemical bounds about 125-150 pm long, versus radiation damage. The entire interaction process is in the fs (femto-seconds) range while the bound and collision propagation time is less than ½ as (atto-seconds), giving enough time the fields to interact and apply selection rules. The good understanding of this process is basic to the further invention development.

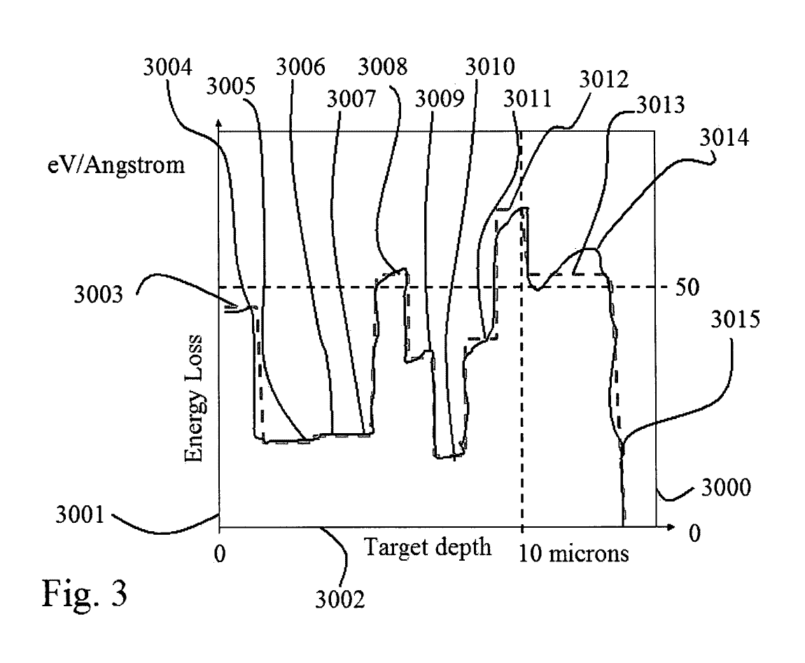

FIG. 3 shows the radiation power deposition by ionization in a sandwich of thin-layered material 5 MeV ⁴He giving the Energy loss versus depth values 3000.

The chart's ordinate giving particle Energy Loss in (eV/Angstrom) for 5 MeV alpha in U 3001, as function of the Target Depth in (micrometers) given by the chart's abscise giving 3002.

The ionization chart 3003 represents the averages for each material used as layer in the target's composition. The energy loss is of 46 eV/A, in the first Carbon layer 3004, 17 eV/A in SiO₂, 3005, 18 eV/A in c (low electron density conductor) material 3006, 18 eV/A in SiO₂ 3007, 53 eV/A in C1 (high electron density conductor type 1) 3008, 35 eV/A in alumina (Al₂O₃) 3009, 15 eV/A in c1 (low electron density conductor type 1) 3010, 40 eV/A in Alumina 3011, 67 eV/A in C2 (high electron density type 2) material 3012, 53 eV/A Alumina (Al₂O₃) 3013, 60 eV/A in Alumina 3014 and, End of particle range in structure 3015 is of 12.6 micrometers.

As was shown in FIG. 1 the ionization induced by the moving particle in the lattice is generating electrons loops degrading and transferring their energy to phonons—the lattice oscillations being known under the name of heat.

To prevent electron-phonon interaction to occur the electrons have to be taken out from the position they arrived and jumped back to recombine with the holes left behind during ionization process. This might be done by creating a conductive/supra-conductive structure to transport the electrons back and in this way the conversion of the energy into heat is avoided inside the irradiated lattice.

FIG. 3 shows an embodiment of the present invention based on a sandwich of various materials that exhibit different ionization rate, generating an electric polarization if put together. The 5 MeV alpha particle stopping in a hetero-structure lattice formed of a conductor, said Au, but possible to use any other material combination exhibiting high electron density as Pu, PuCo₅Ga, U, W, etc. followed by an Insulator material, tunneled by the delta electrons and separated from a low density of electrons material.

The low electron density material is different from a low Z material, by the fact that not only the number of electron per atom matters but also its material crystalline structure and extraction functions, generically characterized by the Fermi sea.

The low electron density material may be Aluminum, Li, LiH, LiBe, Mg, etc. having as main properties a low generation of delta knock-on electrons and a good electric conductivity to carry out the electron shower emitted by the high electron density conductor “C” tunneled through the insulation “I”.

In FIG. 3 for 5 MeV alpha particles it is shown how the deposited energy is varying with depth, and the difference between the material dependent rates. The variation of the energy deposition and the electrons specific energy is further used for material optimization and customization with respect to yield, voltage and current.

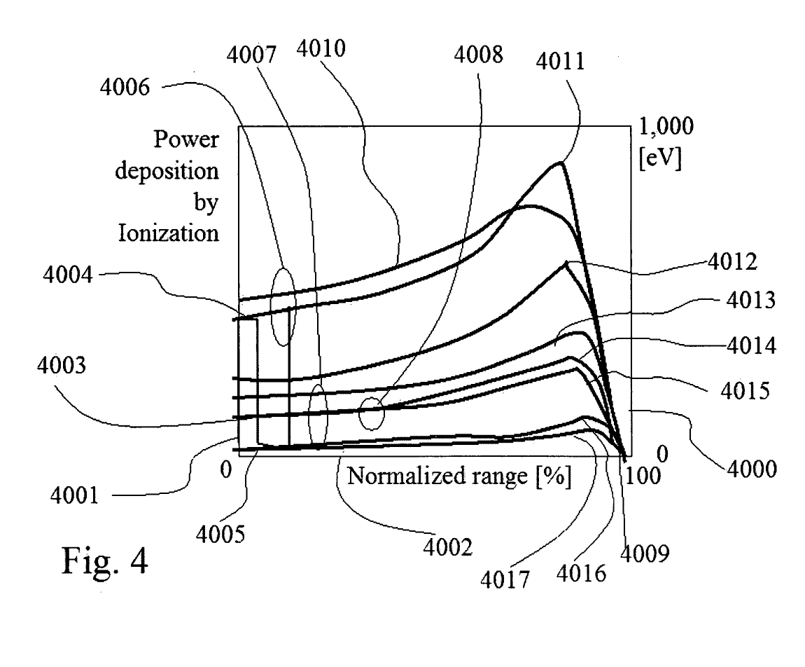

FIG. 4 shows a main embodiment of the present invention with respect to alternate layers stopping power normalized by specific range giving the Energy loss versus normalized depth values in (eV/nm) 4000. It gives a summary of ionization power deposition with respect to different types of materials, classified as conductors and insulators. Chart ordinate giving particle Energy Loss in (eV/nm) for 5 MeV alpha 4001, while the chart abscise giving the Target Depth in percents of the range 4002

In the alternate layers scheme 4003 and chart is seen that the heavy metals as Uranium, gold, etc. are offering a very high stopping power and ionization for almost any particle energy so the range of particles is shorter in these materials.

The materials are grouped on types as high electron density conductors “C” materials 4006, low electron density conductor “c” materials 4007, and insulator type “Ii” materials 4008.

The chart shows that the energy loss in the first “C” of U of 440 eV/nm 4004, while the energy loss in “ci” layer 4005 is 6-8 times lower, driving to a potential polarization issue.

The end of the range point for most of the materials for 5 MeV alphas 4009 is 100% representing the maximum range values for each material.

In conductor class “C” 4006 have been plotted the Gold (Au) energy deposition curve 4010, and Uranium (U) energy deposition curve 4011. Zirconium (Zr) energy deposition curve 4012 represents a median conductivity material while Aluminum (Al) energy deposition curve 4013, Lithium (Li) energy deposition curve 4016 and Lithium Hydride (LiH) energy deposition curve 4017 represents the class “c” 4007. The preferred insulators in class “Ii” 4008 are represented by Alumina (Al₂O₃) energy deposition curve 4014 and Silica (SiO₂) energy deposition curve 4015.

Other low electron density material exhibit average stopping power, but for making an efficient structure there is necessary to select those conductors exhibiting a lower stopping power. Ideally no interaction with initial particles desired but a strong interaction with the delta electrons.

The insulator is desired to have no interaction with the incident radiation and with electrons, just to exhibit mechanical strength of a solid and interaction properties of the vacuum. In reality such material does not exists so low stopping power materials are preferred, and shown in FIG. 4 as I or i. There is a practical difference between the two materials as result of the optimization that will be discussed later. In fact the purpose is to direct as much as possible electrons towards the low electron density conductor while to exhibit high breakdown voltages.

The dotted lines in the left shows that the layers are alternatively used collecting the energy of each layer by turn in the alternant layers of U (cheaper than gold) and LiH it is seen the ration 10:1 between the layers. That pushes the conversion possible limit up to 90% that may be also reduced by the effect of the insulators, down to 80%.

To increase the efficiency there is necessary to use special deposition called delta layers with faceting and compaction effect to increase the electron collection rate while a low voltage made by using porous covalent insulator. Such insulator has time instability issues that require the usage of a compact or gaseous filled insulator.

The industrial optimization criteria have a multi-parametric variety detailed later. From the layer stopping the power to layers using the tunneled electrons average energy to buildup voltage and polarization have to be a smooth connection and is an issue of optimization too. The interest is to have as high as possible voltage and less current in order to have less conductivity issues.

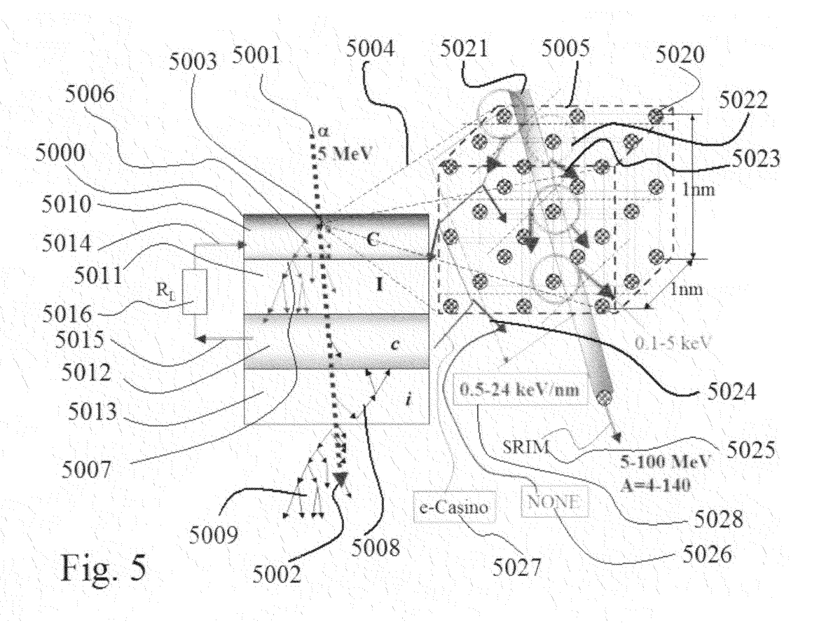

FIG. 5 presents a main embodiment of the present invention referring to alternate layer concept of material interaction with matter, in the elementary cell—the Conductor-Insulator-conductor-insulator structure—“CIci” cell 5000.

In the left side shows a “CIci” layer unit crossed by the moving nuclear particle—alpha particle; fission or fusion product, beta, etc. 5001, exiting 5002 after crossing the interaction volume (voxel) 5003. The radiation in the example is represented by a 5 MeV alpha particle. Other particles as fission products, fusion products, but neutrons, beta and gamma may work as well. For neutrons there is necessary to introduce a reactant in the structure as fissile materials that to show increased reaction cross-section.

A zoom-in volume for interaction details 5004, where the voxel contains 27 atoms 5005. The radiation crossing the layers is interacting with the electron clouds by the ionization process presented in FIG. 1-4.

The knock-on electron generated by ionization process 5006 further interacts with electrons of the lattice generating avalanche electrons sharing the energy and direction of the “ionization” electron 5007 or in opposite direction 5008.

The avalanche electrons in the next “CIci” cell 5009 that is formed by a high electron density conductor “C” 5010, connected at positive pole 5014, an insulator for the electron high-density conductor “I” 5011, a low electron density conductor “c” 5012 connected at a negative pole 5015, and an insulator near low electron density conductor “I” and cell insulator 5013. The electric poles are connected to a load resistor being part of the external circuit 5016.

The knock-on electron are interacting further with the electron clouds forming the delta electrons showers or avalanches that tunnel through the insulator and stop in the low conductor where they compensate for the holes remained after the delta shower originated this layer left, and what left over is inducing the negative polarization of the “c” layer. From here the electrons are living the conductor layer using the external circuit of resistance RL and are returning in the “C” layer remained positive after the massive left of the initial shower not compensated by the previous “c” layer tiny delta shower. In this way the charge is again balanced. The power transmitted to the R_{L} is given by the voltage V=Q/C and the current going through the load resistor R_{L}.

The magnified voxel 5020 shows the nuclear particle entering the voxel 5021, the ionization interaction borders in 3d voxel domain 5022, from where the knock-on electron scattered forward by the particle 5023, and they generate other knock-on electron 5024 sharing the dynamic parameters.

Being cutting edge knowledge, in present there is no molecular dynamics, particle interaction software to treat completely this case. Calculation code used for simulation of the incident nuclear particle was SRIM, 5025 in its various versions over the time starting from old TRIM 94 to the actual SRIM 2006. No actual code is tracking in reasonable condition the high rank knock-on particles forming the avalanches 5026, but indirectly based on transfer file can be covered by e-Casino 5027 or other simulation code used to track the electron behavior, that generates a file that can be iteratively reused, until the avalanche is build and understood. The specific energy deposited by ionization by the primary nuclear particle 5028 can span over a large energy domain and particle type with the cost of customization.

This is a tradeoff subject, as the capacitance of the structure has to be accommodated with the load resistor, radiation source and the efficiency of the harvesting circuit.

The little arrows show the avalanche of delta electrons emerging from “C” layer passing the “I” layer and stops in “c” layer.

The presence of the external circuit is mandatory, because in its absence the voltage accumulated will overpass the breakdown voltage and the circuit will self-damage.

It is also mandatory that the enclosure to be able to handle without failure the stored radiation power.

In the upper right side a 1 nm³ with an average atom distribution of 3 atoms/nm have been taken for exemplification only. This is double as sp²; sp³ bounds distances in carbon structures as nano-tubes and graphene, graphite, diamond, but good enough for low-density materials.

The thick tube 5021 represents the range of potential influence passing through the cubic lattice and touching the electronic orbital. The red arrows are the knock-on electrons sharing a high energy in the domain of 0.5-24 KeV as the ionization density charts shown.

The low energy electrons have increased interaction cross-section with the material's electrons therefore they create an avalanche. It is important that avalanche to have the opportunity to grow and reach its maximum until meeting the “CI” interface and tunneling the insulator “I”.

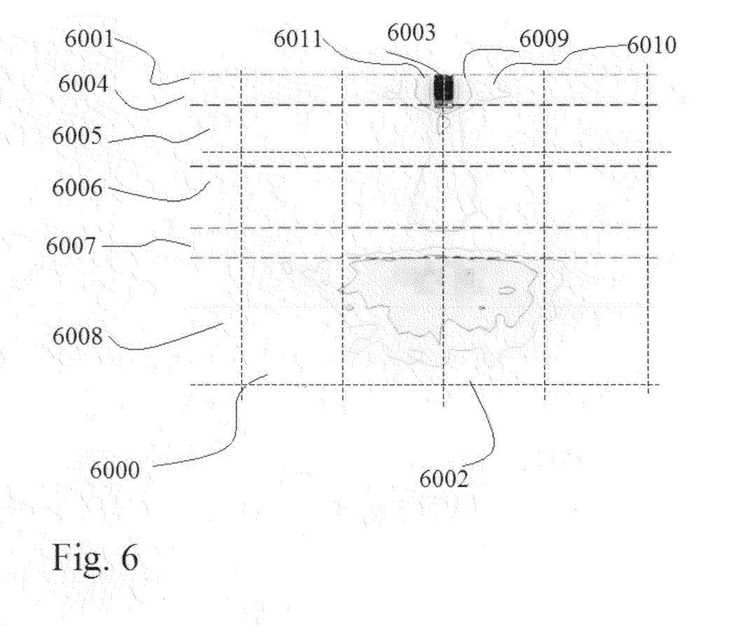

FIG. 6 Shows the e-Casino electron distribution of electrons taking the maximum energy of about 5 KeV from the incident particle as another embodiment. The simulations have been made with e-Casino Monte Carlo code specialized in electrons transport in a 2D section in a multi-layer “CIci” material on gold substrate 6000. The electron particles, the knock-on generated in center, perpendicular with 5 keV energy 6003 entered in the center of upper cell entry surface 6001, having a cell with 6002 of 200 nm and a height in visualization of 100 nm.

In this example the “CIci” structure is made of “C” layer made of gold, 10 nm thick 6004, “I” layer made of 30 nm insulating material 6005, “c” layer made of 50 nm conductive material (i.e. Aluminum) 6006, and the “i” layer made of 20 nm light insulator material 6007 mounted on a gold substrate, thick enough to stop everything 6008.

The electrons are entering the material somewhere at 10 nm from the “CI” interface in “C” gold conductor layer. Gold was taken for exemplification case in practice any material exhibiting high electron density may be chosen. It easily penetrates silica layer and stops in Aluminum or passes further into the next structure generating showers. On all the path the main stopping of these primary knock on electron are produced in the high electro density material, where is the source of delta electrons showers.

The chart shows the isolevel for the 10% electron density of probability 6009, the isolevel for the 5% electron density of probability 6010 and the isolevel for the most of the electron stopping area 6011. This means that the shower is starting of being formed locally, near by (in Debye length) the point of generation of the knock-on.

An important embodiment of the invention is the delta layer of magnetic materials on the “Ic” interface makes that low electrons to change direction along the magnetic layer represented by the strong dotted line, while a multiple delta layer in “ci” interface makes the secondary shower stop and turn back as the effect of a composed magneto electric “Lorentz” type force, that increases the conversion efficiency towards 99%.

The nano-delta layers are a combination of Fe-Ci_Nb, Sm, etc. clusters or other materials exhibiting high magnetic moment deposited in a such a manner as to stop all the avalanche resulted from the “c” and pointing towards “C” conductor, in this manner increasing the equivalent impedance of the low density insulator, and reducing its direct tunneling cross-section.

The next harvesting cell is following immediately in the “iC” interface doped with a delta layer that makes all the backscattered electrons in “C” material to tunnel into “c” layer backwards. The tunneling enhancing material is chosen as function of the electronic band structure of the materials and thickness modified electronic bands such as to unidirectional increase the tunneling by placing the backscattered electrons on a input ballistic trajectory incident on “c” layer.

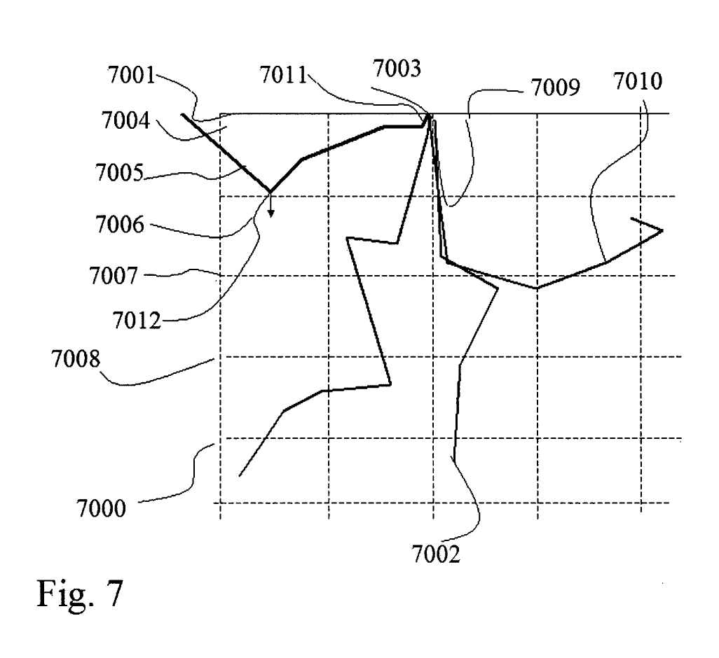

FIG. 7 shows a detail on the electronic optimization of the nano-layers, as another embodiment of the present invention. Because the variety of materials, radiations and structures is so large it shows an accelerator based method meant to optimize the layer thickness for each constructive version and layer. The e-Casino electrons path in a Cici structure formed by Au, SiO₂/Al₂O₃, Al, Alumina details the complications in accurately evaluating the electro shower effectiveness. It shows the electron path in the sandwich structure, the multitude of collisions occurring ending with recoil electron or atomic excitation that have to be considered in the design and optimization process.

It uses the same transversal cut in the nano layer as a 2D section in a multi-layer “CIci” material on gold substrate 7000, this time smaller for detail, having the upper cell entry surface 7001 in the middle, a cell with of 80 nm 7002, a depth or height of 50 nm, along the direction/trajectory of a backscattered electron 7009 of the knock-on generated in center, perpendicular with 5 keV energy 7003

The “CIci” cell is made of “C” layer made of gold, 2 nm thick 7004, “I” layer made of 10 nm insulating material 7005, “c” layer made of 20 nm conductive material (i.e. Aluminum) 7006 and “i” layer made of 10 nm light insulator material 7007, on a gold substrate, thick enough to stop everything 7008.

A very poor statistics of about 25 cases have been used in the exemplification in order to make visible the details of the process like: the trajectory of an electron stopping in the “c” layer 7010, the electrons transferring immediately energy to showers in “C” layer 7011 and the avalanche electron generation 7012.

The optimization is based of building controlled layers by enhanced vacuum deposition methods as chemical vapor, molecular jet, pulsed laser sputtering followed by the specific annealing based on selective beams meant to produce a controllable molecular excitation and chemical bounding.

The produced layers and interfaces are exposed to beam simulating the energy range and particle the material will work in the further harvesting device.

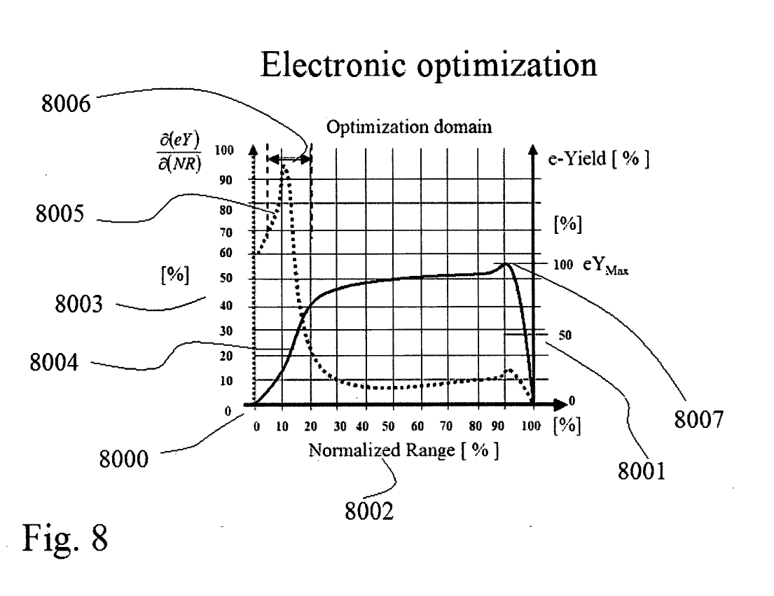

In FIG. 8 is a main embodiment of the invention being a chart showing the basics of electron yield layer thickness optimization procedure 8000, on the right vertical axis is shown the relative electron yield variation, where e-Yield in normalized representation, percents of maximum for each material 8001, with the material thickness, as the normalized electron range 8002. It is observed that following a certain thickness the electron yield platoons and does not depend on the thickness until the end of the range of the primary radiation.

The first partial derivative of the normalized electron yield as function of normalized depth, also called the worth in electrons of a layer 8003 is the main optimization tool according the invention. The e-Yield versus thickness curve in normalized dimensions, 8004 and the partial derivative of the electronic yield versus materiel thickness to its thickness 8005 are used coherently to determine the material layer thickness optimization domain 8006.

At the end of range peak of the electronic yield 8007 due to changes in the reaction cross sections due to the dependence of the time the particle spends in the intra-atomic reaction zone.

The dotted curve represents the tangent on the yield curve, the first partial derivate of yield versus thickness, being proportional with the worth of extra thickness of material. The second derivative of the yield function versus material thickness is giving the worth of the material variation. The curve is good for estimating an optimal initial search value for the material thickness.

The application of the delta layer will induce its variation in near by domain. This method reduces the search domain, by finding the optimal first order area. The database raised in a direct variation will give the minimal time in optimizing the structure and creating production receipts. The double arrow is showing the domain of search for the variation induced by interface and the delta layer.

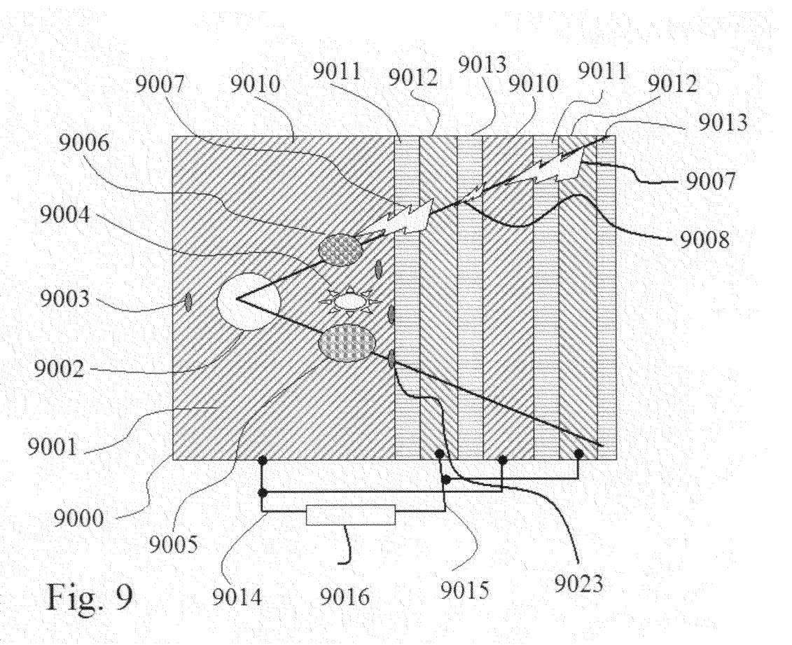

FIG. 9 details the multi-layered concept for fission products application shows how a direct harvesting layer may harvest and amplify the neutrons energy, or operate directly inside a nuclear reactor as fuel, as a main embodiment of the invention showing fission energy harvesting by a “CIci” structure 9000.

A neutron incident on the actinide/fisile material of the structure is inducing the fission, that splits the nucleus in two fission products sharing about 167-170 MeV of kinetic energy. Actinide mixed high electronic density fuel 9001, contains actinides. When a fissile nucleus 9002 is colliding with a neutron 9003 the energy released in various reaction channels 9004 as: two fission products, a lighter one 9005, and a heavier one 9006 almost symmetrical to the median mass, and several fission released neutrons 9023, together with 8 MeV gamma rays and about 8 MeV neutrinos.

The Knock-on electron avalanche induced by fission product stopping in “C” 9007 is by several times bigger than the knock-on electron avalanche induced by fission product stopping in “c” 9008, making the layers polarization possible by the negative charge extraction from the high electron density layer “C” 9010, transport through the insulator “I” 9011, and accumulation on the low electron density conductor “c” 9012 that becomes negatively polarized. The insulator “i” 9013 separates the cell from the adjacent one.

The “C” layer is connected towards the positive polarity plot 9014, and the “c” is connected to the negative polarity plot 9015, that drives the electric field and current through the external load resistor 9016.

Each fission particle crossing the layers is interacting with the atomic and molecular structure first by ionization and then by nuclear recoil at the end of the range. The triangles on the upper particle shows the delta electrons showers starting from the higher electron concentration conductive layers figured as high Z layers, and ending in low electron concentration/generation layers figured by low z layers separated by insulators.

In reality high or low z element matters but is not enough, it has to be doubled by high mass density and low extraction work function that transform these layers in high electron shower generator and low electron shower generator. The delta layers applied for faceting suppressing and redirecting the showers such to suppress emission from the negative layer and to intensify the stopping of electrons into negative layer, while increasing the emission of electrons from the positive layers by a combined action of electric and magnetic nano-fields.

The electric connections in FIG. 7 are made in parallel that makes high current and low voltage at acceptable limits determined by the breakdown voltage of the insulator. For protection reasons the system will have a voltage temperature switch that will drive the current through the protection resistor, preventing the circuit worm up. The energy of 167 MeV released as kinetic energy during the fission process is equal with 26.7 pW that supposing is harvested at 10 mV and 2.67 nA or at 1 V and 26.7 pA.

A complex optimization between the harvesting required thickness and the current flow internal resistance have to be performed as to maximize the power density parameter. This makes the thickness of the insulator layer of limited functionality as increasing the thickness the conversion efficiency decreases.

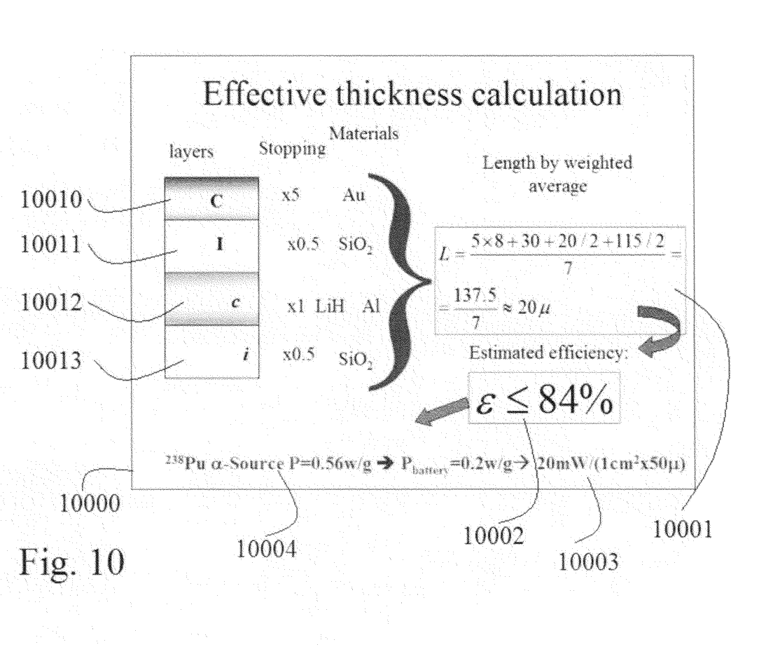

FIG. 10 shows an example of thickness calculation of a CIci elementary cell based on primary particles energetic considerates only.—It is an indirect thickness estimation method 10000 based on stopping range based estimation formula 10001.

Shows a sample of estimative calculation using a material estimative method. The layers of the “CIci” structure are dimensioned in such a way as total stopping power in Gold representing the “C” conductor to be 5 times higher that that stopped in “c” conductor and insulator “Ii” layers taken together. The “CIci” structure was choused as follows: the “C” layer made of gold (Au) stopping 5 ionization absorption units of weight 10010, the “I” layer made of silica (SiO₂) stopping 0.5 units of weight 10011, the “c” layer made of Aluminum or Lithium Hydride (Al or LiH) stopping 1 units of weight 10012, the “i” layer made of silica (SiO₂) stopping 0.5 units of weight 10013, as finally to obtain about 7 ionization energy absorption units of weight, to cover the total 5 MeV of the alpha radiation or 100 MeV of fission products.

That simply projects the estimative total thickness for the 5 MeV alpha particles at about 20 microns. The design has to offer the capability of the stopped alpha particles as He atoms to diffuse through the structure and be released.

The calculated efficiency of 84% is simply the efficiency of ionization energy stopped in the “C” layer. To be a real accurate evaluation it has to consider all the electrons and excitations inside the material. That is hard to obtain by theoretic calculations and have to be obtained by experimental buildup, using the methodology described at FIG. 8. The actual calculated efficiency remains upper conversion efficiency estimator 10002 only because it did not includes the rest of the aspects in the device.

Using the ³⁸Pu power characteristics 10004, and the efficiency estimated values, the potential power expected for a 1 cm ²×0.05 mm ²³⁸Pu battery 10003 may be also estimated and have to be interpreted as maximal value.

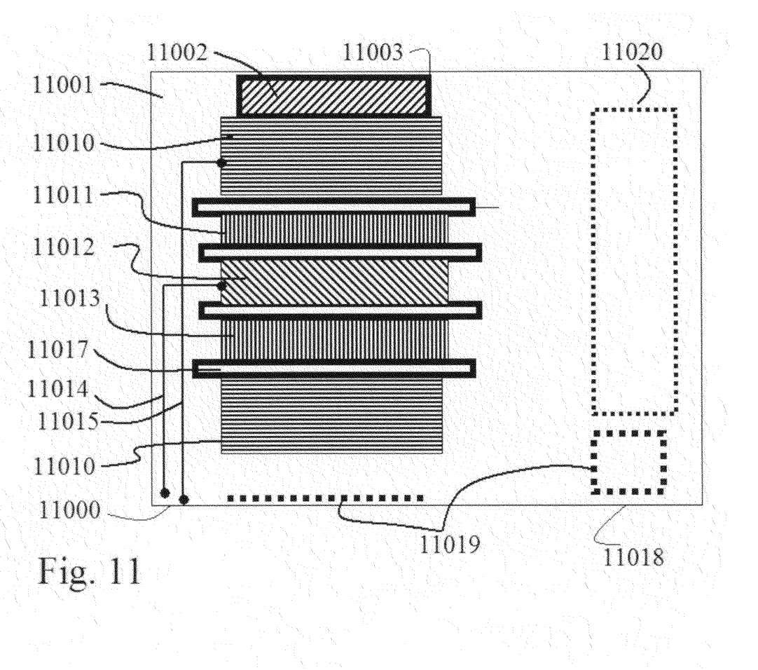

FIG. 11 shows an example of radioactive battery structure based on harvesting “CIci” cell cross section, 11000. The radioisotope battery structure where the radioactive isotope is in center on the symmetry axes 11001, where the fissile material or radioisotope 11002 is placed making the radiation pointing outside through the entire sandwich and stopping in the cladding that also have the role of attenuating the associated X and gamma radiation.

The dimensions in the structure are to be fixed and customized as function of materials used in the structure composition and radiation type.

The minimal dimensions of the structure are in the range of 20-40 microns for alpha and fission products as well for beta. Battery layers schematic view 11020 shows that the structure is made of: high electron density layer “C” 11010, insulator “I” 11011, low electron density conductor “c” 11012 and insulator “i” 11013, connected to the positive polarity plot 11014, and to the negative polarity plot 11015, respectively.

The “δ” layer are used to accommodate the fissile material 11003 and the harvesting materials 11017.

More of the same layers repeated as harvesting cell until span over the range 11019 until it reaches the cladding or cell packing material 11018.

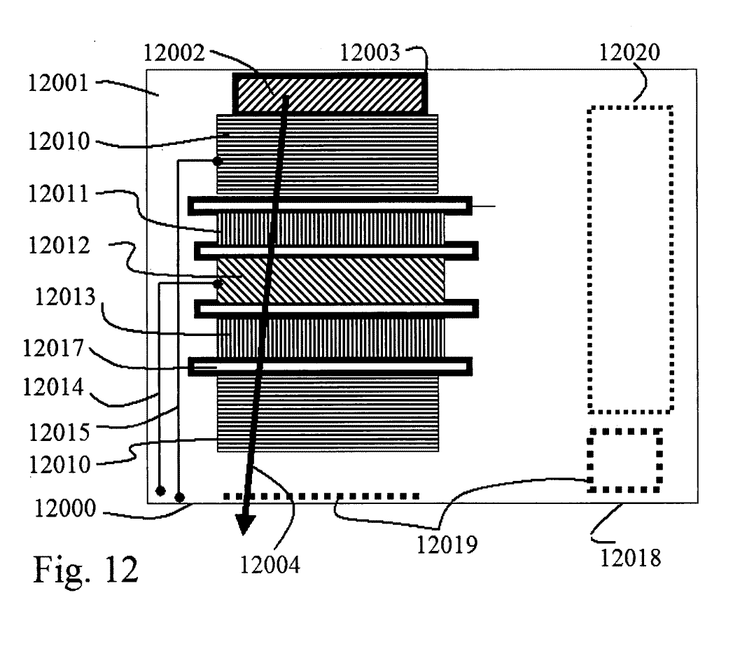

FIG. 12—Example of planar alpha radioisotopes battery structure for alpha particles energy harvesting “CIci” cell cross section 12000.

Shows a section through a planar “CIci” structure with reference on the central symmetry axes 1200, where the fissile material or the radioisotope 12002 is placed, but it is designed as an alpha battery.

The radioisotope is one of the over 40 alpha emitters having the lifetime in the interval of few days to few hundred years. It may be one of over 60 beta emitters that may also be used but with power densities by 100 times or more lower. Gamma rays and neutrons may also be used but their high penetration makes the battery impractical for economic reasons and power density.

The zoom in the “CIci” structure show the importance of delta layers interfacing the nano-layers. The specialized “δ” layer to accommodate the fissile material 12003 and the harvesting materials 12017. The “CIci” perpendicular on the nuclear radiation path 12004 is formed by High electron density layer “C” 12010, Insulator “I” 12011, Low electron density conductor “c” 12012, and Insulator “i” 12013. The “C” layers are connected to the Positive polarity plot 12014, and the “c” layers are connected to the negative polarity plot 12015.

Cladding or cell packing material 12018 shields the cell.

The assembly of the entire battery contains several hundreds cells customized to materials, radiation and position in the cell, formed by a plurality of more of the same layers repeated as harvesting cell until span over the range 12019 as shown in the battery layers schematic view 12020. The thickness of 20-40 microns is the right value for this type of device.

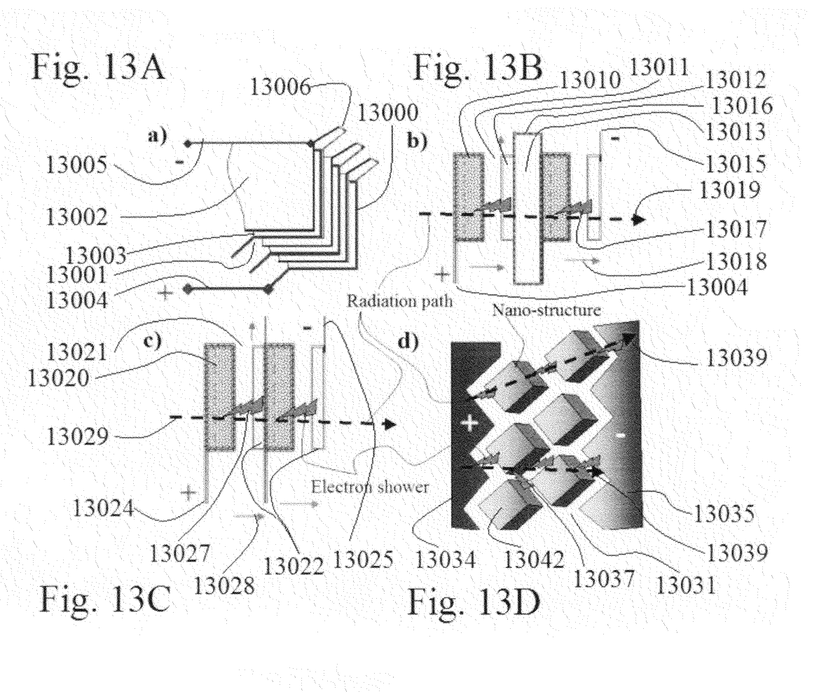

FIG. 13 shows a structural morphing from parallel capacitor in FIG. 13A to nano-particulate capacitor and super dielectric creation based on plasmon nano-cluster resonance shown in FIG. 13D. It has the capability to separate the optimal thickness from the optimal voltage and current to be extracted from the structure.

FIG. 13A shows a view of the serial connection of the “CIci” nanolayers perspective view, made of the “C” conductor layer 13000, the “I” insulator 13001, the “c” conductor layer 13002 and the the “i” insulator layer 13003. The “C” layer is connected to the positive pole “+”13004 and the “c” is connected to the negative pole “−” 13005. Inside a serial internal strap 13006 is connecting the plates.

Connecting the structure in series will drive the voltage up and reduce the current to be transversally transported through the layer conductivity to require the increase of the layer's section in detriment of the efficiency.

FIG. 13 a shows the connection in series of the previous structure in FIG. 11 such as the current remain constant and uniform among the repetitive cells while the voltage is added.

Looking in longitudinal section we observe how one insulator is electrically removed from the circuit and may be physically removed. It is also observed that a bimaterial structure is created.

[FIG. 13B—Serial connection of the “CIci” nanolayers longitudinal section view. The structure is made of the “C” conductor layer 13010, the “I” insulator 13011, the “c” conductor layer 13012 and the “i” insulator layer 13013. The “C” layer is connected to the positive pole “+”13014 and the “c” is connected to the negative pole “−” 13015. Inside a serial internal strap 13016 is connecting the plates.

Analyzing the importance of the low density layer “c” in the functional structure can be reduced to a delta layer with the single purpose of minimizing the backscattered electrons.

The electron avalanche 13017 make the electron current flow sense 13018 with the primary nuclear radiation path and direction 13019.

It is observed now that the transversal conductivity among the lateral parts of a conductive surface does not matter so much in spite it is good for potential uniformity.

FIG. 13C —Evolved serial connection of the “CIci” nanolayers longitudinal section view. The structure is made of the “C” conductor layer 13020, the “I” insulator 13021, and the “c” conductor layer 13022. The “C” layer is connected to the positive pole “+”13024 and the “c” is connected to the negative pole “−” 13025. Inside, the electron avalanche 13027, goes with the electron current flow sense 13028, following the primary nuclear radiation path and direction 13029.

FIG. 13D shows the “CIci” nanocluster longitudinal section view as result of the conne The structure is made of the “C” conductor layer 13030, and the “I” insulator 13031. The “C” layer is connected to the positive pole “+”13034 and the “c” is connected to the negative pole “−” 13035. Inside, the electron avalanche 13037 among the nano-cluster beads 13042, follows the primary nuclear radiation path and direction 13039.

The structure can be optimized and ruddgesied as fabricated as mesh or successive beads or a combination. Naturally a nano-layer evolves towards agglomerations and segregation structures that sometime drive to nano beads or nanocluster becoming very stable.

The lateral conductivity is good but not important to keep an uniform electric field inside The size of insulator layers the shape and distance of the nano-beads is a subject of optimization as well as bimaterial structure and nano-layer faceting.

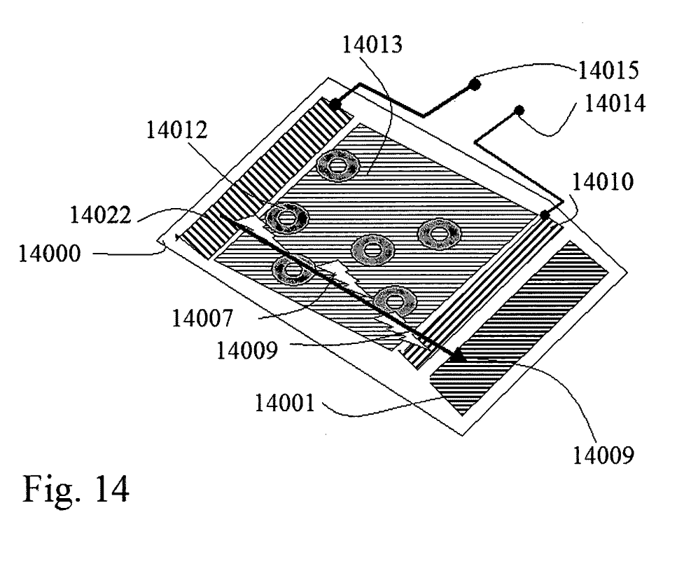

FIG. 14—Parallel plasmon nano-cluster cell 14000 for radiation harvesting and radiation and also functioning as switched thermo-electric device radiation triggered.

The nuclear fuel 14001 is added on one or two sides at a maximum solid angle of 2π for a single cell. The electron avalanche 14007 follows the primary nuclear radiation path and direction 14009, taking the electrons from the “C” conductor layer 14010 carrying them across the “i” insulator 14013 making them jump on the adjacent nano-cluster beads 14022 and dropping them on the negative pole “−” 14015, while living the holes on the positive pole “+” 14014.

An evolved form of the device is the creation of a new material/insulator type. The pads of conductivity being tailored very small in the nano-cluster domain and separate by nm thick insulator (as silica alumina, etc.) are reaching the domain where the plasmon effects gain in importance. The nano-beads may be simple or bi-material placed at a distance acceptable for tunneling the knock-on electrons.

A radioisotope layer having a thickness such as to minimize the autoabsorption and to increase the number of particles in a reasonable manner forms the structure in FIG. 14. Up to 5-10% autoabsorption level should be accepted. From this layer the particles are emitted in a isotropic manner and are crossing the dielectric material hitting the beads inside.

The high electron density material near the isotopic material and the beads are emitting equivalent delta-electron showers along the particle that can be a fission product or a radiation corpuscle connecting the beads by an electric discharge all along the path.

The current is constant all along the stages formed by the nanobeads while the voltage builds-up. In this moment the nano-beads are electrically coupled each other having an electronic transport for several picoseconds.

The electric discharge has the effect of transporting all the electrons in conduction upper bands through the system down to the low electron density layer. The effect is that supposing a higher temperature is made between the two electrons driving to a Fermi level and electron density difference generated by material difference—High/Low electron density and temperature difference the circuit opens and transports all the extra charge plus the delta-electrons avalanche towards the low density material.

The system acts as a cooler-direct conversion of heat flow into electricity, having a material type induced equilibrium temperature gradient that makes that the center of the structure where the radioactive element is to be cooled down to several tenth of degrees than the borders, making the energy loose by autoabsorption insignificant.

The high efficiency fast switched thermo-electric device created uses the radiation to trigger the cooling of the center. It is possible to use both effects creating a cooler that to generated both electricity from radiation direct conversion and cold.

In Quantum Mechanics term the eigen function of the resonance plasmon-phonon and plasmon electron have been matched in the same structure and same time. The extreme grids with low and high electron density materials are connected to the plots taking the produced current outside on a load resistor.

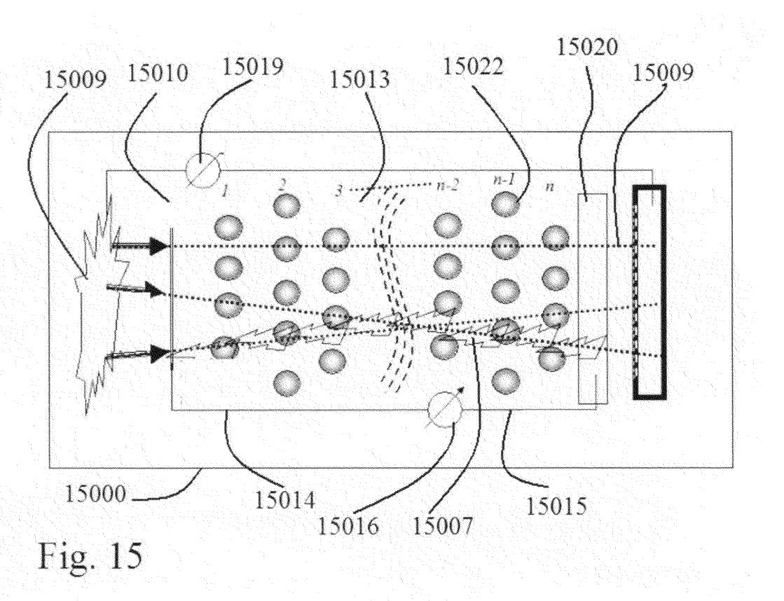

FIG. 15 shows another embodiment of the invention as a Nano-cluster plasmonic structure beam test setup as super-capacitor is designed in order to help the material optimization using accelerated ion beams instead or radioactive sources. The beam input side in the left is facing a thin (hundreds of nm to microns thick) high electron density layer with the capability of being heated by irradiation with a laser or other heat source.

The nano-clustered cell for ion beam energy harvesting device 15000 generates a chain of electron avalanche 15007 when crossed by the primary nuclear radiation (ion beam) path and direction 15009, connecting the nano-cluster beads 15022 on its path.

The structure is made of the “C” conductor layer (possibly made of Au) 15010, the “i” insulator 15013, fulfilling the space between the positive pole “+” 15014 and the negative pole “−” 15015.

The structure is design for the test there fore is equipped with a measuring instrument for the current harvested energy 15016, connected between the “c” conductor end layer 15020 and the “C” conductor layer (possibly made of Au) 15010, and an Ammeter measuring the radiation particles beam current 15019.

The beads inside have the faceting shape varied by material matching and annealing processes. Ion beams at high dose may be used in order to obtain a stabilized structure insensitive to radiation damage. The beads are varied as size, shape, orientation such as to be possible to measure the both effects direct conversion of nuclear radiation, and the radiation switched thermo-electric.

The beam is measured by using the stopper deposition as well the differential measurement between the input beam and total beam stopped.

The stopper may be the substrate or may be different from the harvesting structure. The collector to the nano-foils that may have intermediary positions voltage, current and local temperatures are also measured.

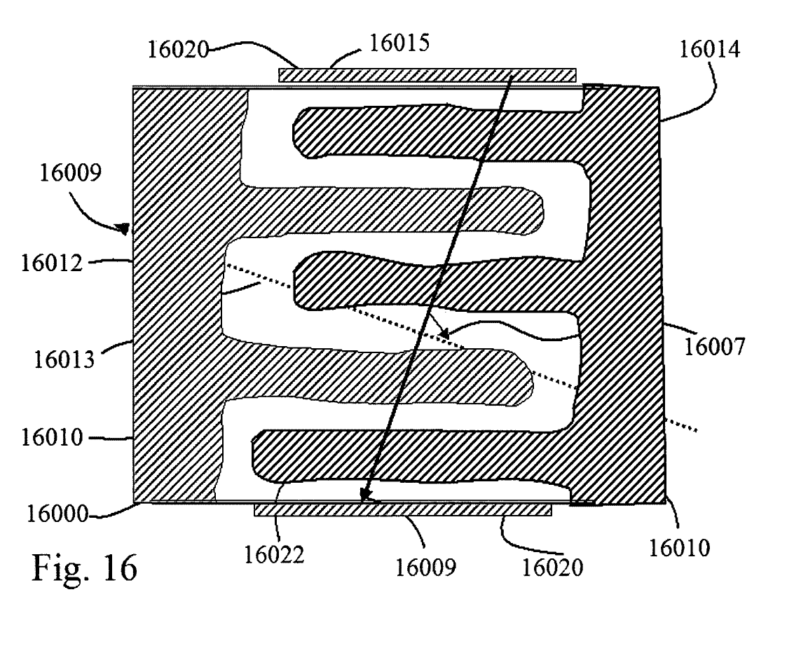

FIG. 16—MWNano Structure—coated nanowire or carbon nanotube ultra capacitor structure. Following the shape morphs inside the initial capacitor like structure in FIG. 13 resulted that the insulated nano-cluster is not the unique shape the material may be organized to become more stable and efficient. Other structures are possible as nano-wires and nano-tubes.

The Multi Wall Carbon Nano-clustered tube cell for energy harvesting 16000, is made of the “C” conductor layer (possibly made of Au) 16010, and the “c” material (possibly made with LiH) 16012, separated by the “i” insulator 16013 provided by CNT. The positive pole “+”16014 is connected to Au substrate 16010, while the negative pole 16015 is connected to the “c” conductor end layer 16020. Inside the CNT there are nano-cluster beads 16022 or a kind of nano-wire or liquid conductor.

The electron avalanche 16007 follows the primary nuclear radiation (ion beam) path and direction 16009

The desired property is to alternate the high density with low electron density material separated by an insulator. It is also desired as the one-dimensional shapes to exhibit high resistivity along the radiation path and low resistivity in the perpendicular plane if possible to generate equipotential arrays in order to make an uniform electric field. All these properties together with a good radiation robustness.

The coated nano-wire systems may be used to to generate a part of the structure. Therefore the coated Uranium, Plutonium nano-wires may be inserted in LiOH and coated with an oxide layer forming a dense structure with mm dimensions. This structure may be used as part of a active structure where the mass ration between active radioisotope to rest may rich values as high as 80% driving to a maximum of 6 w/cm3 for 238 Pu source, and more than 250 W for a 210 Po. Other carbide based structures containing simply carbides and Li metal may by developed.

Another alternative is to use multi wall carbon nano-tubes MWCNT prepares in such a manner as to exhibit no radial conductivity with good longitudinal conductivity. The Nanotubes have to be fulfilled inside with the high electron density material “C” while immersed in a “c” electrolyte as LiH, forming a pseudo-ultra-capacitor structure.

Trapping inside “C” material while immersed into a “c” material may use the C bulky balls and fulerens. The fulerene C60; C-70, etc. solution may be used inside a structure with the grids made from the two materials in order to show a polarization. The use of the electrolyte may favor that one of the poles to be made by a conductive grid immersed into electrolyte, while the other pole to be made by high electron density case.

The advantage of these structures is the lack of any dependence on directivity of radiation. No matter the radiation direction the polarization is made in the same way, the “c” electrolyte minus while the “C” case plus. Enhanced insulator structure as TiO₂ or RuO₂ able to carry volts may be also developed with care to auto-absorption of primary radiation effects and conversion efficiency.

The principle of conversion is shown in FIG. 16 where a primary radiation in red is crossing the structure in a random direction. It produces showers of knock-on electrons that negatively polarizes the LiH electrolyte. The thermal effect may cool down the case while maintaining LiH at a higher temperature, the heat being extracted as electric current. This kind of dual type of source of electricity and cool may be used to cool down the active elements it powers, the heat being mowed to resistor. Active self powered self cooled electronic devices as transistors, electronic circuits are possible to achieve as application of this nuclear battery device.

The radiation is increases the radiation robustness of the CNT or Bukyballs by generating a sp2 to sp3 transition and cross linking among the multiple nano-walls. The C exceptional radiation stability makes the nuclear absorption very small, these structures doped with actinides may be suitable for nuclear reactor fuel. Wigner disease, being very small to these porous structures while fission products eliminating devices may be produced due to self stress and porosity of these nano-structures.

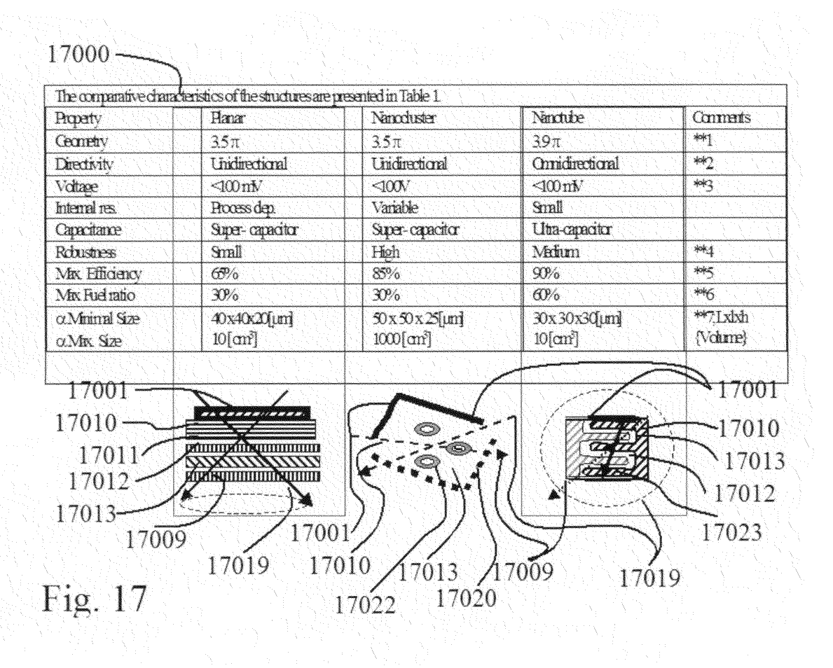

FIG. 17—Table with properties of the structures and evaluation shows briefly the exceptional properties offered by these nano-structures in the main three constructive versions, and ignoring the subversion diversification in a comparative table for the three main structures 17000.

The Table shows a brief classification after the main geometric structure in three main categories, but in reality there are many more versions.

The planar structure refers to the continuous nano-layers deposited on a flat substrate. It may have versions as instead a uniform nano-layer it may have a mesh, or a distribution of shapes interconnected electrically for electric field uniformity reasons.

The Nano-cluster is referring to a structure made from consecutive layers of nano-beads, with cluster or near cluster sizes sealed in an amorphous insulator material operating as radiation avalanche mediator and radiation switched thermoelectric.

The “CIci” planar structure is made of the nuclear radiation source; fissile fuel or radioisotope 17001, the “C” conductor layer (possibly made of Au) 17010, the “I” insulator 17011, The “c” material (possibly made with LiH) 17012, the “i” insulator 17013, the positive pole “+” 17014, and the negative pole “−” 17015. at the “c” conductor end layer 17020.

After case they contain nano-cluster beads 17022 or MWCNT with high electron density core 17023. The Primary nuclear radiation path and direction 17009 and the solid angle 17019 is also shown.

The nanotube versions are including all kind of one dimensional structures as nano-tubes, nanowires having good axial conductance but low transcersal conductance. A special position is allocated to C structures as MWCNT, buckyballs etc. The considerations are related to capacitance, conductivity robustness.

The Geometry refers to the radiation emission solid angle 17019 that gives contribution to the conversion effect, and the radiation paths is crossing a significant number of layers.

The planar structures has “dead” angles along the structure while the nanostructure with the nanowires and nanotubes center connected to poles have increased solid angle. Only a small fraction of radiation traveling parallel with the structure resistance box is lost for conversion purposes.

The directivity is an important feature that determines the location and amount of radioactive source. The nano-wires and nano-tubes connected structures have no directivity preferences accepting the radioactive material be even mix in electrodes and allowing a higher power density.

The voltage on plots is determined by voltage rigidity/breakdown of the insulator being a fraction of this say 50%. The serial structures add voltage while the parallel structures add current. There is a materials composition optimum for voltage and current that determines the inner connection.

Capacitance is another factor, that is determined by the constructive solution. The nano-structures based device drives the capacitance in the domain of ultra or super capacitors.

A high capacity with good internal conductivity makes the device suitable to power pulsed power regimes and variable consumption.

Robustness is an important factor, and is characterizing the structure from various aspects. The Small robustness qualification is showing that uniform us nanolayers are difficult to fabricate and maintain their electrical conductivity in the radiation and temperature field. These are suitable for micron size batteries. The annealed nano-cluster surface seems to be the most robust structure as it does not exhibit thermal expansion issues and the equilibrium amorphous material is already stable to radiation damage. In spite high dpa dose it may take the functionality and efficiency are not changed with dose.

The solid angle, geometry, resistance, autoabsorbtion, etc. determine maximal efficiencies but the values are given as theoretical maximal values. The effect of delta-layers and magnertic layers are not considered in these calculations for simplicity purposes.

Minimal size is important feature. It basically says that no structure smaller then 2 ranges of the radiation in that specific structure is reasonable to build up. In special circumstances 1 micron battery may be made, but having a 5% efficiency, and better tradeoffs of size, power, lifetime may be found.

The maximal dimensions are mainly driven by criticality conditions for the sources using actinides in various environments and radiation reflectors. The structure has not to overpass a 25% criticality, being deep uncritical and remaining so even in a compact pile of batteries. The power and power density is a complex issue that have been analized separately.

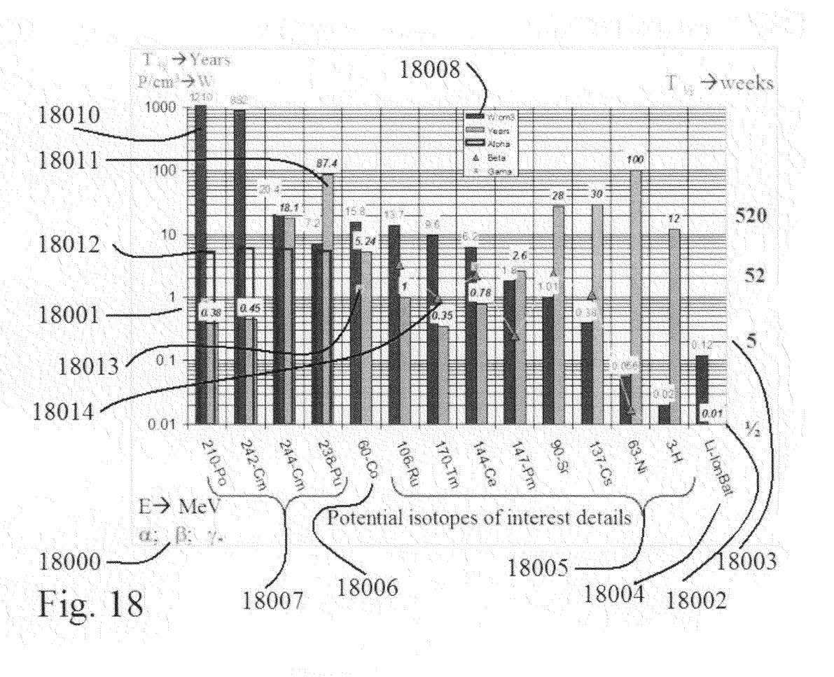

FIG. 18—Synthetic view of Power density versus duration and collateral radiation of several isotopes possible of being used in radioisotope batteries say a The table with potential isotopes of interest 18000.

It is seen that the average alpha particles emitted by heavy metals energy is about 5 MeV. This is due to the binding energy in He atoms higher by more than 1.25 MeV/nucleon than the specific binding energy in all heavy nuclei. Small variations in the range of 20% exist from isotope to isotope due to its specific internal nuclear structure.

The ordinate in logarithmic scale is representing specific power, in [W/cm³], Half-life time in [Years] 18001. The abscise is listing a few isotopes of potential interest, and Li-Ion battery as reference 18002, while the second ordinate showing the halving time in [weeks], as a translation from the first ordinate 18003, and the legend 18008 shows what is represented.

Li-Ion Battery power-Duration performances 18004 have been included as reference, to compare with the beta emitter isotopes 18005, the gamma emitter—isotope ⁶⁰Co 18006 and the alpha emitter main isotopes 18007.

The power density bars 18010 with the value in [W/cm³] above, the half-life time in [years] with the value above the bar 18011, the alpha emitter Energy in [MeV], 18012, the gamma ray energy (associated with alpha and beta emission) in [MeV] 18013 and the beta particle average energy in [MeV] 18014.

The chart shows a tradeoff between the power density that is given by the number of alpha particle rate or the decay constant, and the lifetime of the source that is the inverse of the decay constant.

On the chart the pink columns represent the specific power released by 1 cm3 of pure isotope compound, while the blue bar represents the halving time in years on the same left scale, and on the right scale is the value in weeks.

The red contour over the bars is the radiation type and energy in MeV, represented with a triangle for beta and with a red x-cross for gamma.

The power density considers all the radiation emitted by the isotope. It is observed that all beta emitters have specific power under 20 W/cm3 for halving times less than 1 year.

The most used T and Ni emitters have very small power densities compared with that of Lilon batteries. All the alpha sources exhibit power densities several orders of magnitude higher. In spite 60Co good performances, the penetrability of gamma rays of 1.332 and 1.17 MeV of about 1 ft makes it unpractical for power generation.

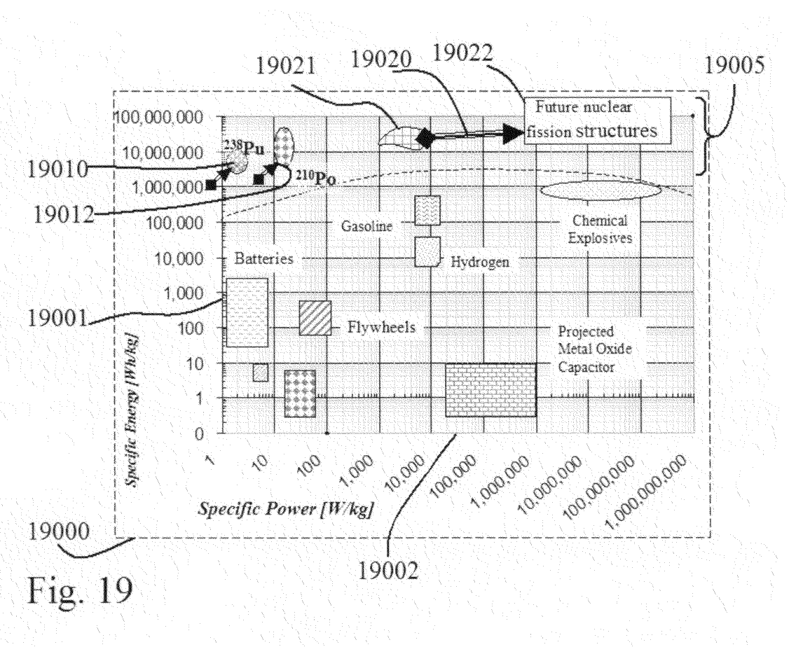

FIG. 19—Synthetic placement of the new power sources on the fuels, storage devices map that shows the placement of these new nuclear power sources among the other already known nuclear power sources; this Chart showing the specific Energy-Power performances of various energy sources 19000.

The ordinate in log. Scale showing the specific energy in [Wh/kg] 19001, the abscise showing the specific power in [W/kg] 19002.

It is seen as ²³⁸Pu source is well above any battery, while the enhancement from the actual thermo-electric piles to the direct harvesting structure is shown by the double arrow covering the parameters dispersion. ²¹⁰Po sources are better placed because the short time makes possible a better power extraction. After 14 month the power becomes 10% from the initial power.

On upper side is shown the improvement in Radioisotope batteries ²³⁸Pu case 19010, the placement of novel ²¹⁰Po batteries 19012.

The nuclear energy domain 19005 placement shows the special characteristics of nuclear power, with potential improvement in fission nuclear reactors performances 19020, from the position of the present nuclear reactors 19021 towards the position of the novel direct conversion fission structures 19022.

The actual nuclear reactor structures may also be improved to a high level of about 1 GWday/Kg and significant power densities at GW/Kg level limit. These unprecedented values may assure new performances for the powered devices and utilities.

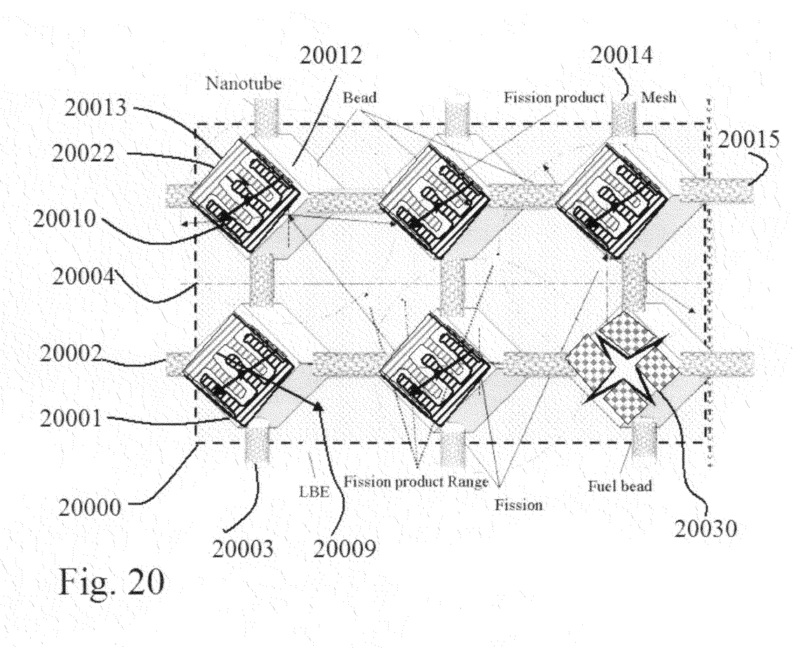

FIG. 20—Perfect burning clean microstructures, as an alternative to combine the near perfect burning with direct conversion I a micro nano-hetero structure voxel 20000.

The elementary cell is made in a spherical case favoring a small bead of fissile material in the center of about 2 microns radius and is surrounded by concentric layers of harvesting structures.

The fuel micro-bead containing the nano-structure 20001 is hold on horizontal wires for support and electric conduction 20002, for one polarit series, while the perpendicular wire for elastic support and electric conduction 20003 may be used to connect the structure in parallel.

As to previous micro-hetero structure the liquid metal is a fission product carrier 20004 taking the primary nuclear radiation (fission product) no matter their path and direction 20009.

The harvesting nano structure may be made of a “C” conductor layer (possibly made of Au) 20010, “c” material (possibly made with LiH) 20012, “i” insulator 20013 and the “c” conductor end layer 20020, having the positive pole “+”20014, and the negative pole “−”20015 respectively connected to the support wires and grounded in drain liquid.

The harvesting structure may be made of nano-cluster beads direct conversion structure 20022, or eight conversion nano-structure pack micro-bead 20030 may be used to increase the fissile to passive ratio.

The fission products emerging from the center are stopping in the border range of the fluid in contact with the drainage liquid. The liquid may or may not take part at the conductivity process. The connecting wires may be made from bundles of carbon nanotubes or micro-wires as tungsten. The structure has to exhibit radiation robustness and elasticity in order to be suitable of being compressed. The wires have to be insulated from the drain liquid The wires may be made as conic springs or other structure to compensate for the damage induced by radiation.

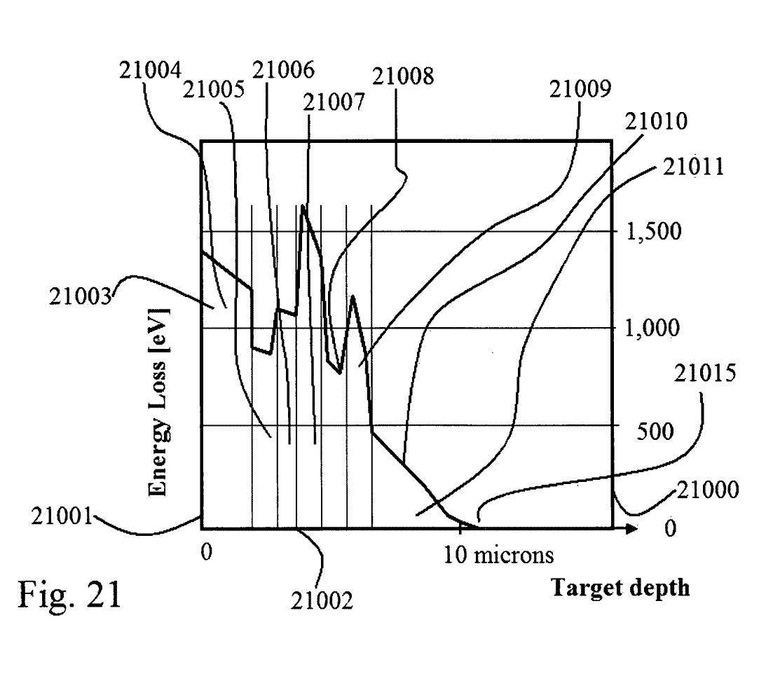

FIG. 21—Ionization power deposition of fission products into a sandwich micro-nano-structure as an example of the customization needed. It shows the typical ionization diagram for fission products and the need to apply a complex position, energy material optimization.

The last power deposition may be made in a liquid acting as a liquid semiconductor junction slightly polarized ti further capture the charge induced by the radiation in the last percents of the range. The red surface on the plot represents the ionization power deposition versus depth for various material sandwich took as exemplification. The blue small curve on the bottom shows the the nuclear recoil area where the damage is maximal. These area have to be placed in liquid in order to minimize the damage. The liquid may aso act as a conductor, to harvest its final energy too.

21000—The Energy loss versus depth values
21001—Chart ordinate—particle Energy Loss in (eV/Angstrom) for 100 MeV ¹³⁵Cs in U
21002—Chart abscise giving the Target Depth in (micrometers)
21003—The Ionization chart
21004—The energy loss in the first urania (UO₂) layer of 1300 eV/A
21005—Energy loss in Al of 930 eV/A
21006—Energy loss in Urania material of 1100 eV/A
21007—Energy loss in Cu material of 1600 eV/A
21008—Energy loss in Urania material of 825 eV/A
21009—Energy loss in gold (Au) material of 1125 eV/A
21010—Energy loss in Lead-Bismuth LBE (PbBi) material of 500-0 eV/A
21011—Energy loss by nuclear recoil in LBE material of 90 eV/A
21015—End of particle range in structure of 12.6 micrometers

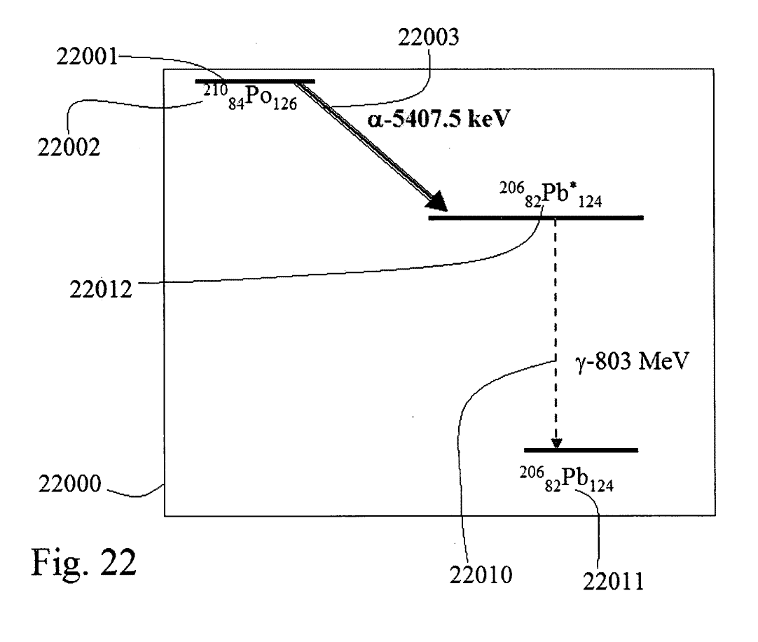

FIG. 22—210 Po decay scheme shows the specific energies of the nuclear reactions that have to be considered for any isotope involved in the process. It shows that it has a single alpha decay driving into an excited state of 206 Pb with a 803 KeV gamma decay. But very low occurrence probability of 10⁻⁵. That means that at each Kw of alpha power 1-2 mW of gamma power is also released. This will require 10 cm of lead shielding for power supplies over 10 W if used in near by proximity.

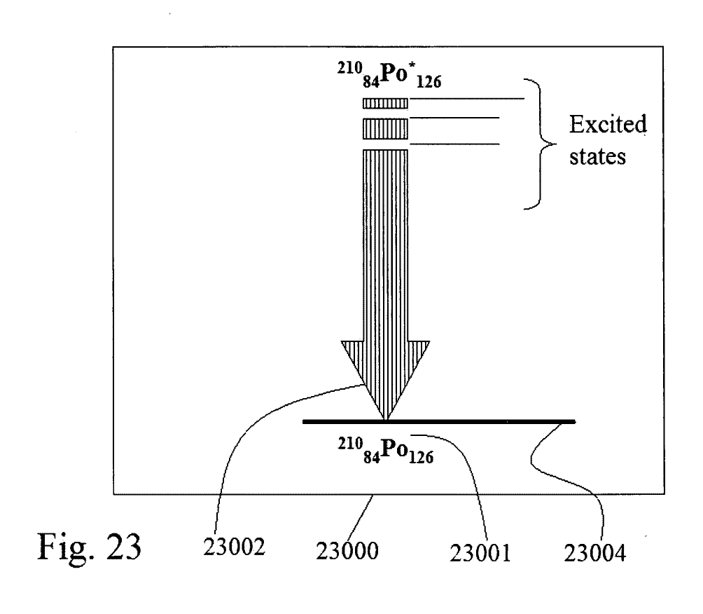

22000—²¹⁰Po decay energetic diagram
22001—²¹⁰Po in ground state
22002—²¹⁰Po element column
22003—The alpha decay of 4516 MeV
22010—The gamma decay of ²⁰⁶Pb
22011—The ²⁰⁶Pb in ground level
22012—The excited level of ²⁰⁶Pb at 803.1 keV
FIG. 23—210 Po energetic levels structure is useful to understand and have in mind due to potential auto excitation of the nuclear states by alpha collisions with asls low probability in domain under 10⁻⁶ as well any other material in contact with radiation.
23000—Chart of energy levels of ²¹⁰Po
23001—²¹⁰Po in ground state prior to alpha decay
23002—Internal energetic transitions in ²¹⁰Po
23004—Energy levels of internal excitation of ²¹⁰Po

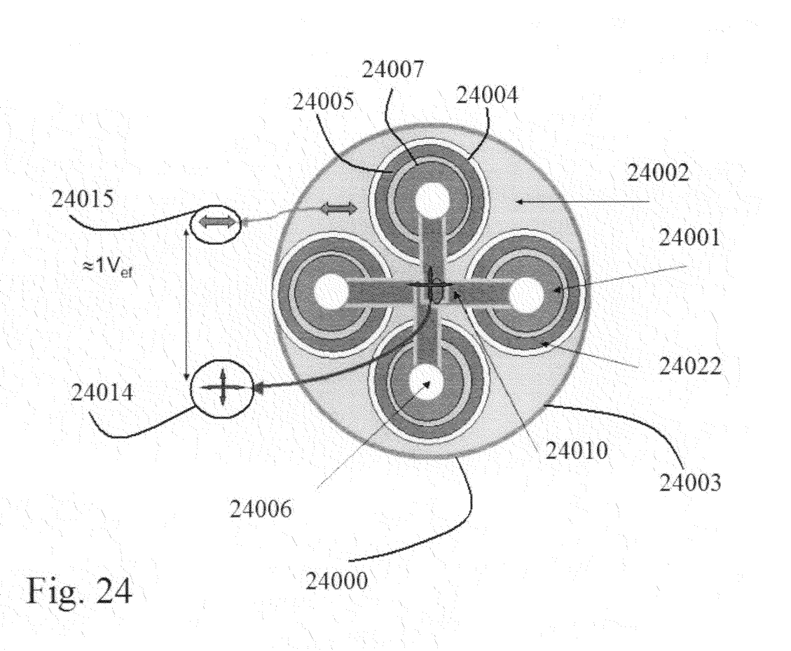

FIG. 24—The integrated direct harvesting structure into a cer-liq microstructure FIG. 24 is an extension of FIG. 20 showing a potential bundle combination of the nanospheres connected on nanotubes. The white gray part inside the nanosphere is for fuel or radioactive isotope.

Deposited around nanotube or conductor soldering. The concentric lares are made in various constructive structures detailed above in order to increase the harvesting efficiency. Finally it ends in an insulator outer sphere coating the last converter material.

In plasmonic structure is OK to let the last part of the stopping range to be converted in temperature in the stopping liquid and converted back in electricity by the switched radiation driven thermoelectric device in the yellow coating insulator. Dedicated wires will harvest the energy and sent towards a DC/AC converter.

24000—micro-tube with drain liquid for direct conversion microbeads
24001—Fuel (possibly urania)
24002—Drain liquid (possibly LBE or NaK)
24003—Micro-tube external structure
24004—Micro-bead insulating coating
24005—Nano-hetero direct conversion structures
24006—Empty central hole
24007—Fuel central bead coating
24010—Electric connections inside the tube
24014—Positive plot
24015—Negative plot
24022—Internal nano-cluster direct harvesting structure

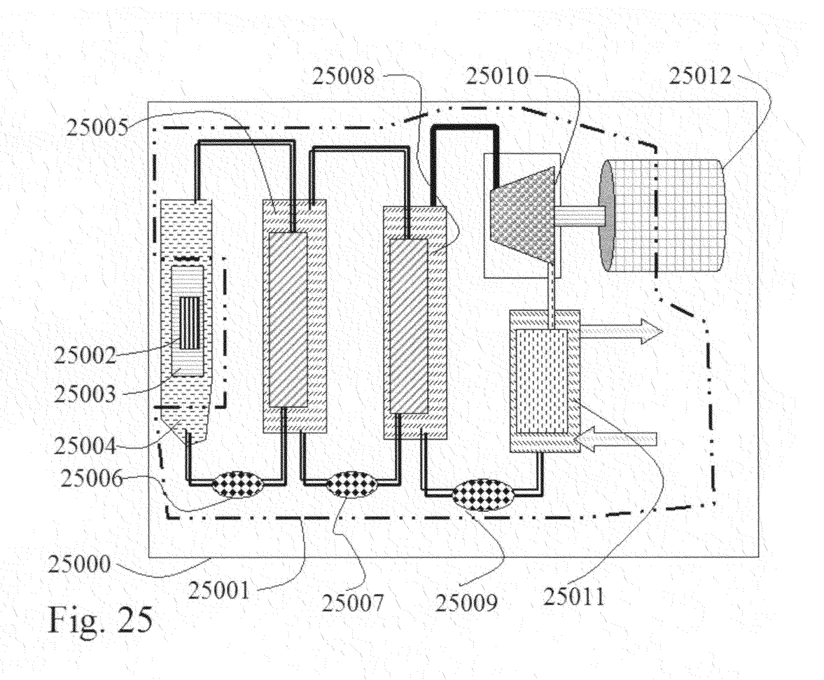

FIG. 25—Nuclear reactor energy conversion cycle simplification brought by this type of

Direct conversion nuclear reactor. From the actual cycle only the nuclear reactor core and the last part of the generator that delivers the electric power to grid is supposed to remain. It is possible to create a version of nuclear direct conversion reactor with power electronics to deliver directly in the grid without a mechano-electric adapter.
25000—The Nuclear reactor block diagram
25001—The parts removed by the new technologic solution
25002—Nuclear reactor core
25003—Cooling and control systems
25004—Shielding and cooling systems
25005—Primary circuit heat exchanger
25006—Primary liquid pump
25007—Secondary liquid pump
25008—Secondary heat exchanger
25009—Tertiary liquid pump

### 25010—Turbine

25011—Condenser cooled by water
25012—Electric power generator

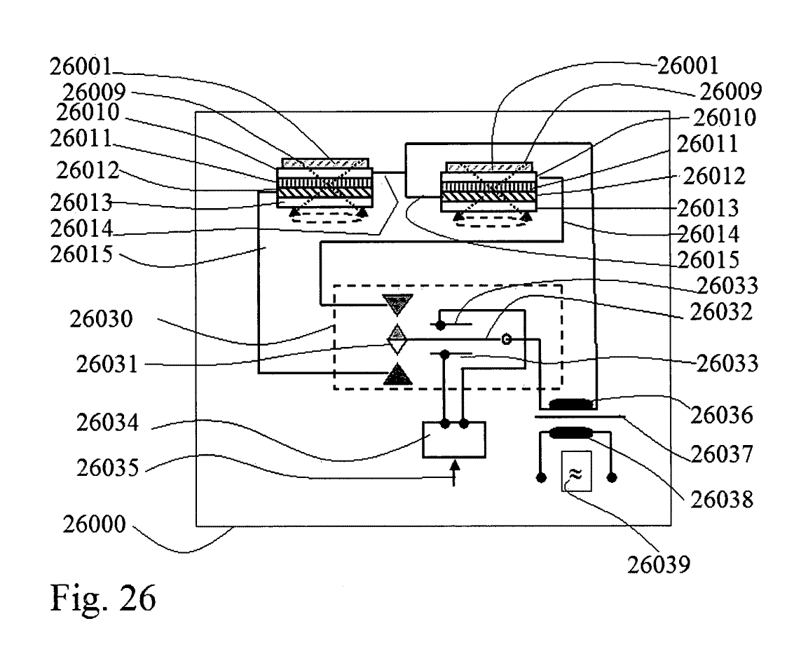

FIG. 26 Electric power conversion DC/AC MEMS inverter.

26000—The MEMS DC/Ac converter
26001—Nuclear fuel or radioisotope
26009—Nuclear radiation path
26010—High electron density layer “C”

### 26011—Insulator “I”

26012—Low electron density conductor “c”.
26013—Insulator “i”
26014—Positive polarity plot
26015—Negative polarity plot
26030—MEMS switch vibrator
26031—Vibrator contact
26032—Piezo-electric or electric sensitive cantilever
26033—Cantilever blade actuators
26034—Power and phase control of the vibrator
26035—Input signal for vibrator control
26036—micro-transformer—primary coil
26037—magnetic core
26038—Secondary coil
26039—Extraction of the AC power

### SUMMARY OF FIGS AND THEIR DESCRIPTIONS

FIG. 1—Radiation particle energy deposition in matter 100 MeV ¹⁴⁰Cs in UO₂

1000—The Energy loss versus depth values
1001—Chart ordinate giving particle Energy Loss in (eV/Angstrom) for 5 MeV alpha in U
1002—Chart abscise giving the Target Depth in (micrometers)
1003—The Ionization chart
1004—The energy loss in recoil creation

FIG. 2 Radiation interaction with C atoms as a subatomic process exemplification

2000—The interaction of the nuclear particles with atoms
2001—The atom structure (a Carbon atom)
2002—The atom's nucleus
2003—Electron orbital with distributed charge mass
2004—Electron particle stand
2005—Moving nuclear particle
2006—Electric potential interaction with the electron knocking-on the electron
2007—Knock-on electron
2008—Knock-on electron by central moving potential electric field acceleration

FIG. 3 Radiation power deposition by ionization in a sandwich of thin layered material 5 MeV ⁴He, as an exemplification of the radiation power deposition process as the base of this invention.

3000—The Energy loss versus depth values
3001—Chart ordinate giving particle Energy Loss in (eV/Angstrom) for 5 MeV alpha in U
3002—Chart abscise giving the Target Depth in (micrometers)
3003—The Ionization chart
3004—The energy loss in the first Carbon layer of 46 eV/A
3005—Energy loss in SiO₂ of 17 eV/A
3006—Energy loss in c material of 18 eV/A
3007—Energy loss in SiO2 material of 18 eV/A
3008—Energy loss in C1 material of 53 eV/A
3009—Energy loss in alumina (Al2O3) material of 35 eV/A
3010—Energy loss in c1 material of 15 eV/A
3011—Energy loss in Alumina material of 40 eV/A
3012—Energy loss in C2 material of 67 eV/A
3013—Energy loss in Alumina (al₂O₃) material of 53 eV/A
3014—Energy loss peack in Alumina material of 60 eV/A
3015—End of particle range in structure of 12.6 micrometers

FIG. 4—Main embodiment of the invention meant to assure the correct operation of alternate layers stopping norm by specific range, dotted lines showing the effect of alternate hereto-structures in the simplest shape of layers

4000—The Energy loss versus normalized depth values in (eV/nm)
4001—Chart ordinate giving particle Energy Loss in (eV/nm) for 5 MeV alpha
4002—Chart abscise giving the Target Depth in percents of the range
4003—The alternate layers scheme
4004—The energy loss in the first “C” of U of 440 eV/nm
4005—Energy loss in “ci” layer
4006—High electron density conductors “C” materials
4007—Low electron density conductor “c” materials
4008—Insulator type “Ii” materials
4009—End of the range point for most of the materials for 5 MeV alphas.
4010—Gold (Au) energy deposition curve
4011—Uranium (U) energy deposition curve
4012—Zirconium (Zr) energy deposition curve
4013—Aluminum (Al) energy deposition curve
4014—Alumina (Al₂O₃) energy deposition curve
4015—Silica (SiO2) energy deposition curve
4016—Lithium (Li) energy deposition curve
4017—Lithium Hydride (LiH) energy deposition curve

FIG. 5—A detail of the main embodiment of the invention showing the atomistic view of the particle interaction with alternate layer hetero-material, forming the (Conductor-Insulator-conductor)-insulator also called “CIci” structure, the elementary brick of the structure

5000—The elementary cell—the Conductor-Insulator-conductor-insulator structure—“CIci” cell.
5001—The moving nuclear particle—alpha particle; fission or fusion product, beta, etc.
5002—The exit of the nuclear particle
5003—The interaction volume (voxel)
5004—The zoom-in volume for interaction details
5005—The voxel containing 27 atoms
5006—knock-on electron generated by ionization process
5007—Avalanche electrons sharing the energy and direction of the “ionization” electron
5008—Avalanche electron following opposite direction
5009—Avalanche electrons in the next “CIci” cell
5010—High electron density conductor “C”
5011—Insulator for the electron high-density conductor “I”
5012—Low electron density conductor “c”
5013—Insulator near low electron density conductor “I” and cell insulator
5014—Positive pole
5015—Negative pole connecting low electron density conductors “c”
5016—Load resistor being part of the external circuit
5020—The magnified voxel
5021—The nuclear particle entering the voxel
5022—Ionization interaction borders in 3d voxel domain
5023—Knock-on electron scattered forward by the particle
5024—Knock-on electron scattered by the previous knock-on electron
5025—Calculation code used for simulation of the incident nuclear particle
5026—No actual code is tracking in reasonable condition the high rank knock-on particles forming the avalanches
5027—Simulation code used to track the electron behavior
5028—The specific energy deposited by ionization by the primary nuclear particle

FIG. 6—Knock-on electron distribution simulated by e-Casino, showing the electron avalanche formation in C layer and its absorption in c layer as an embodiment of the invention

6000—2D section in a multi-layer “CIci” material on gold substrate
6001—Cell entry surface
6002—Cell with
6003—Knock-on generated in center, perpendicular with 5 keV energy
6004—“C” layer made of gold, 10 nm thick
6005—“I” layer made of 30 nm insulating material
6006—“c” layer made of 50 nm conductive material (i.e. Aluminum)
6007—“i” layer made of 20 nm light insulator material
6008—The gold substrate, thick enough to stop everything
6009—The isolevel for the 10% electron density of probability
6010—The isolevel for the 5% electron density of probability
6011—The isolevel for the most of the electron stopping area

FIG. 7—e-Casino electrons path in a Cici structure formed by Au, SiO₂/Al₂O₃, Al, Alumina as a mock structure and embodiment of the invention

7000—2D section in a multi-layer “CIci” material on gold substrate
7001—Cell entry surface
7002—Cell with of 80 nm.
7003—Knock-on generated in center, perpendicular with 5 keV energy
7004—“C” layer made of gold, 2 nm thick
7005—“I” layer made of 10 nm insulating material
7006—“c” layer made of 20 nm conductive material (i.e. Aluminum)
7007—“i” layer made of 10 nm light insulator material
7008—The gold substrate, thick enough to stop everything
7009—The trajectory of a backscattered electron
7010—The trajectory of an electron stopping in the “c” layer
7011—The electrons transferring immediately energy to showers in “C” layer
7012—Avalanche electron generation

FIG. 8—Electronic optimization of the nano-layers as a embodiment of the invention and a particularization of the method described in previous patent at the electron gas level as tool of designing the structure

8000—Chart showing the basics of electron yield layer thickness optimization procedure
8001—e-Yield in normalized representation, percents of maximum for each material
8002—The normalized electron range
8003—First partial derivative of the normalized electron yield as function of normalized depth, also called the worth in electrons of a layer
8004—The e-Yield versus thickness curve in normalized dimensions
8005—The partial derivative of the electronic yield versus materiel thickness to its thickness
8006—Material layer thickness optimization domain
8007—End of range peak of the electronic yield

FIG. 9—Multi-layered concept for fission products application, as a detaliation of the fission-products application

9000—Fission harvesting “CIci” structure
9001—Actinide mixed high electronic density fuel
9002—Fissile nucleus
9003—colliding neutron
9004—Energy released in various reaction channels
9005—Lighter fission product
9006—Heavier fission product
9007—Knock-on electron avalanche induced by fission product stopping in “C”
9008—Knock-on electron avalanche induced by fission product stopping in “c”
9010—High electron density layer “C”

### 9011—Insulator “I”

9012—Low electron density conductor “c”.
9013—Insulator “i”
9014—Positive polarity plot
9015—Negative polarity plot
9016—Load resistor
9023—Fission released neutrons

FIG. 10—Example of thickness calculation of a CIci elementary cell based on mezoscopic evaluations as an embodiment of the invention

10000—Indirect thickness estimation method
10001—Stopping range based estimation formula
10002—Upper conversion efficiency estimator
10003—Potential power estimation for a 1 cm ²×0.05 mm ²³⁸Pu battery
10004—²³⁸Pu power characteristics
10010—The “C” layer made of gold (Au) stopping 5 units of weight
10011—The “I” layer made of silica (SiO₂) stopping 0.5 units of weight
10012—the “c” layer made of Aluminum or Lithium Hydride (Al or LiH) stopping 1 units of weight
10013—The “i” layer made of silica (SiO₂) stopping 0.5 units of weight

FIG. 11—Example of radioactive battery structure as embodiment of the invention being similar to that for fusion and fission products energy harvesting

11000—Harvesting “CIci” cell cross section
11001—Central symmetry axes
11002—Fissile material or radioisotope
11003—“δ” layer to accommodate the fissile material
11010—High electron density layer “C”

### 11011—Insulator “I”

11012—Low electron density conductor “c”.
11013—Insulator “i”
11014—Positive polarity plot
11015—Negative polarity plot
11017—“δ” layer to accommodate the harvesting materials
11018—Cladding or cell packing material
11019—More of the same layers repeated as harvesting cell until span over the range
11020—Battery layers schematic view

FIG. 12—Example of planar alpha radioisotopes battery structure as a particularization of the harvesting structure

12000—Harvesting “CIci” cell cross section
12001—Central symmetry axes
12002—Fissile material or radioisotope
12003—“δ” layer to accommodate the fissile material
12004—Nuclear radiation path
12010—High electron density layer “C”

### 12011—Insulator “I”

12012—Low electron density conductor “c”.
12013—Insulator “i”
12014—Positive polarity plot
12015—Negative polarity plot
12017—“δ” layer to accommodate the harvesting materials
12018—Cladding or cell packing material
12019—More of the same layers repeated as harvesting cell until span over the range
12020—Battery layers schematic view

FIG. 13—A main embodiment of the invention showing the structural morphing from parallel capacitor FIG. 13A, to nano-particulate capacitor and super dielectric creation based on plasmon nano-cluster resonance FIG. 13D.

FIG. 13A—Serial connection of the “CIci” nanolayers perspective view

13000—The “C” conductor layer
13001—The “I” insulator
13002—The “c” conductor layer
13003—The “i” insulator layer
13004—The positive pole “+”
13005—The negative pole “−”
13006—The serial internal strap

FIG. 13B—Serial connection of the “CIci” nanolayers longitudinal section view

13010—The “C” conductor layer
13011—The “I” insulator
13012—The “c” conductor layer
13013—The “i” insulator layer
13014—The positive pole “+”
13015—The negative pole “−”
13016—The serial internal strap
13017—The electron avalanche
13018—The electron current flow sense
13019—Primary nuclear radiation path and direction

FIG. 13C—Evolved serial connection of the “CIci” nanolayers longitudinal section view

13020—The “C” conductor layer
13021—The “I” insulator
13022—The “c” conductor layer
13024—The positive pole “+”
13025—The negative pole “−”
13027—The electron avalanche
13028—The electron current flow sense
13029—Primary nuclear radiation path and direction

FIG. 13D—The “CIci” nanocluster longitudinal section view

13030—The “C” conductor layer
13031—The “I” insulator
13034—The positive pole “+”
13035—The negative pole “−”
13037—The electron avalanche
13039—Primary nuclear radiation path and direction
13042—Nanoc-cluster beads

FIG. 14—Another embodiment of the invention referring to parallel plasmon nano-cluster cell for radiation harvesting and radiation switched thermo-electrics

14000—Nanoclustered cell
14001—Nuclear fuel
14007—The electron avalanche
14009—Primary nuclear radiation path and direction
14010—The “C” conductor layer
14013—The “i” insulator
14014—The positive pole “+”
14015—The negative pole “−”
14022—Nanoc-cluster beads

FIG. 15 Accelerator energy harvesting setup, another embodiment of the invention showing the Nano-cluster plasmonic structure as special properties super-capacitor.

15000—Nano-clustered cell for ion beam energy harvesting
15007—The electron avalanche
15009—Primary nuclear radiation (ion beam) path and direction
15010—The “C” conductor layer (possibly made of Au)
15013—The “i” insulator
15014—The positive pole “+”
15015—The negative pole “−”
15016—The measuring instrument for the current harvested energy
15019—Ammeter measuring the radiation beam current
15020—The “c” conductor end layer
15022—Nano-cluster beads

FIG. 16—Another embodiment of the invention made by the development of MWNano Structure—coated nanowire or carbon nanotube ultra capacitor structure

16000—Multi Wall Carbon Nano-clustered tube cell for energy harvesting
16007—The electron avalanche
16009—Primary nuclear radiation (ion beam) path and direction
16010—The “C” conductor layer (possibly made of Au)
16012—The “c” material (possibly made with LiH)
16013—The “i” insulator
16014—The positive pole “+”
16015—The negative pole “−”
16020—The “c” conductor end layer
16022—Nano-cluster beads

FIG. 17 Table with properties of the structures and evaluation of the various versions of development of the direct power conversion structures

17000—Comparative table for the three main structures
17001—The nuclear radiation source; fissile fuel or radioisotope
17009—Primary nuclear radiation path and direction
17010—The “C” conductor layer (possibly made of Au)
17011—The “I” insulator
17012—The “c” material (possibly made with LiH)
17013—The “i” insulator
17014—The positive pole “+”
17015—The negative pole “−”
17020—The “c” conductor end layer
17022—Nano-cluster beads
17023—The MWCNT with high electron density core

FIG. 18 Synthetic view of Power density versus duration and collateral radiation of several isotopes, referring to the isotopic batteries as a byproduct of the invention

18000—The table with potential isotopes of interest
18001—The ordinate in logarithmic scale representing specific power, in [W/cm³], Half-life time in [Years]
18002—The abscise listing a few isotopes of potential interest, and Li-Ion battery as reference
18003—The second ordinate showing the halving time in [weeks], as a translation from the first ordinate
18004—Li-Ion Battery power-Duration performances
18005—The beta emitter isotopes
18006—The gamma emitter—isotope ⁶⁰Co
18007—The alpha emitter main isotopes
18008—The legend
18010—The power density bars with the value in [W/cm³] above
18011—The half-life time in [years] with the value above the bar.
18012—The alpha emitter Energy in [MeV]
18013—The gamma ray energy (associated with alpha and beta emission) in [MeV]
18014—The beta particle average energy in [MeV]

FIG. 19 Synthetic placement of the new power sources on the fuels, storage devices map, showing the superiority of the new developments over the present structures

19000—Chart showing the specific Energy-Power performances of various energy sources
19001—The ordinate in log. Scale showing the specific energy in [Wh/kg]
19002—The abscise showing the specific power in [W/kg]
19005—Nuclear energy domain
19010—Improvement in Radioisotope batteries ²³⁸Pu case.
19012—The placement of novel ²¹⁰Po batteries
19020—Improvement in fission nuclear reactors performances
19021—The position of the present nuclear reactors
19022—The position of the novel direct conversion fission structures

FIG. 20 A main embodiment of the invention, as a consequence of the application of the method to fission products release in order to generate the fusion between micro and nano structure to create fission products clean micro-nano-structures

20000—Micro nano-hetero structure voxel
20001—Fuel micro-bead containing the nano-structure
20002—Horizontal wire for support and electric conduction
20003—Perpendicular wire for elastic support and electric conduction
20004—Liquid metal fission product carrier
20009—Primary nuclear radiation (fission product) path and direction
20010—The “C” conductor layer (possibly made of Au)
20012—The “c” material (possibly made with LiH)
20013—The “i” insulator
20014—The positive pole “+”
20015—The negative pole “−”
20020—The “c” conductor end layer
20022—Nano-cluster beads direct conversion structure
20030—Eight conversion nano-structure pack micro-bead

FIG. 21—Ionization power deposition of fission products into a sandwich micro-nano-structure as a exemplification of the structure application to fission products energy harvesting

21000—The Energy loss versus depth values
21001—Chart ordinate—particle Energy Loss in (eV/Angstrom) for 100 MeV ¹³⁵Cs in U
21002—Chart abscise giving the Target Depth in (micrometers)
21003—The Ionization chart
21004—The energy loss in the first urania (UO₂) layer of 1300 eV/A
21005—Energy loss in Al of 930 eV/A
21006—Energy loss in Urania material of 1100 eV/A
21007—Energy loss in Cu material of 1600 eV/A
21008—Energy loss in Urania material of 825 eV/A
21009—Energy loss in gold (Au) material of 1125 eV/A
21010—Energy loss in Lead-Bismuth LBE (PbBi) material of 500-0 eV/A
21011—Energy loss by nuclear recoil in LBE material of 90 eV/A
21015—End of particle range in structure of 12.6 micrometers

FIG. 22 ²¹⁰Po decay scheme as application on isotopic short life high power isotopic batteries

22000—²¹⁰Po decay energetic diagram
22001—²¹⁰Po in ground state
22002—²¹⁰Po element column
22003—The alpha decay of 4516 MeV
22010—The gamma decay of ²⁰⁶Pb
22011—The ²⁰⁶Pb in ground level
22012—The excited level of ²⁰⁶Pb at 803.1 keV

FIG. 23 ²¹⁰Po energetic levels structure as an exemplification of the complexity of the nuclear reaction channels used in the battery

23000—Chart of energy levels of ²¹⁰ Po
23001—²¹⁰Po in ground state prior to alpha decay
23002—Internal energetic transitions in ²¹⁰Po
23004—Energy levels of internal excitation of ²¹⁰Po

FIG. 24—The integrated direct harvesting structure into a cer-liq microstructure as another main embodiments of the structure.

24000—micro-tube with drain liquid for direct conversion microbeads
24001—Fuel (possibly urania)
24002—Drain liquid (possibly LBE or NaK)
24003—Micro-tube external structure
24004—Micro-bead insulating coating
24005—Nano-hetero direct conversion structures
24006—Empty central hole
24007—Fuel central bead coating
24010—Electric connections inside the tube
24014—Positive plot
24015—Negative plot
24022—Internal nano-cluster direct harvesting structure

FIG. 25 Nuclear reactor energy conversion cycle simplification from the present nuclear-thermal-mechanical-electric cycle, resulted by applying the direct nuclear fission conversion into electric power instead

25000—The Nuclear reactor block diagram
25001—The parts removed by the new technologic solution
25002—Nuclear reactor core
25003—Cooling and control systems
25004—Shielding and cooling systems
25005—Primary circuit heat exchanger
25006—Primary liquid pump
25007—Secondary liquid pump
25008—Secondary heat exchanger
25009—Tertiary liquid pump

### 25010—Turbine

25011—Condenser cooled by water
25012—Electric power generator

FIG. 26 Electric power conversion DC/AC MEMS inverter.

26000—The MEMS DC/Ac converter
26001—Nuclear fuel or radioisotope
26009—Nuclear radiation path
26010—High electron density layer “C”

### 26011—Insulator “I”

26012—Low electron density conductor “c”.
26013—Insulator “i”
26014—Positive polarity plot
26015—Negative polarity plot
26030—MEMS switch vibrator
26031—Vibrator contact
26032—Piezo-electric or electric sensitive cantilever
26033—Cantilever blade actuators
26034—Power and phase control of the vibrator
26035—Input signal for vibrator control
26036—micro-transformer—primary coil
26037—magnetic core
26038—Secondary coil
26039—Extraction of the AC power

What is claimed is:

1. A nuclear energy harvesting system made of a plurality of modular structures
made of a combination of nano-layers sandwiches, containing structures as nano-clusters, nano grains and nanowires and nano-tubes and combinations of those together with radioactive or fissile material.

2. A nuclear energy harvesting system according claim 1 placed in combinations with the structure.

3. A nuclear energy harvesting system, according claim 1 converting the energy of radiation into electric current obtained at the plots of a solid structure made on nano-hetero materials.

4. A nuclear energy harvesting system according claim 1 forming a device having the elementary unit made of a sequence of conductor insulator conductor insulator nano-layers or nano-structures that one has the property to interact with the primary radiation and generate a large avalanche knock-on electrons while the other conductor has very low interaction with radiation and low electron production but high absorption of the electron avalanche becoming negatively polarized while the insulators prevents the electrons returning.

5. A device according the claim 4 where the nano-layers may be messes or wire or segregation structures in electric contact and insulated in the structure.

6. A device according to claim 4 being made by a plurality of elementary cells

7. A device according to claim 4 having the nanolayers properties increased by delta layers and annealing and faceting photo -thermo-chemical treatments.

8. A device according to claim 4 being made by a suspension of plasmon nano-clusters acting as radiation harvesting electron transport and as thermo electric radiation triggered switch for heat to electricity conversion and transport.

9. A device according to claims 4 made by a plurality of plasmon cells integrated in a greater assembly separated by electric planes and conductor.

10. A device according claims 4 made from a plurality of nanotubes, MWCNTs, treated wall nano-wires, immersed in a LiH, Na, AlH, electrolyte as the negative pole, and connected to the case as the positive pole.

11. A device according to claims 4 having the high electron density conductor and poles made of a combination of actinide and other heavy metals with active roll in neutron harvesting and/or criticality, possible being used for reactor fuel.

12. A device according to claims 4 being powered by a radioactive source emitting alpha particles, beta particle, fission products

13. A device according to claims 4 using MWCNT filled with heavy metals and inserted into low electron density electrolyte.

14. A device, according claim 4 forming an elementary harvesting cell coupled in series or parallel to adjust the voltage.

15. A device as in claim 4 delivering the power to a MEMS DC/AC switch and converter producing a synchronous higher voltage to prepare for external delivery outside the reactor or battery unit.

16. A device according claim 4 used in panels to harvest various radiation or antennae for space applications of beamed power and thrust

17. A device according claim 4 based on plasmon resonances to cool-down the circuit and to convert heat in electricity cooling the associated electronics

18. A device, according claim 4 formed a plurality of elementary cells and integrated on active elements of electronics as power and cooling source, mowing all the power on the external resistance.

19. A device, according claim 4 configured as a radioactive battery morphed on electronic cases, power electronics, distributed micro-power device.

20. A device according to claims 4 used as nuclear fuel in a mix nuclear structure being having the power producing beads fixed on conductive nanowires and immersed in a drain liquid to remove the fission products while directly generating electricity.
